(19) United States
(12) Patent Application Publication
(10) Pub. No.: US 2009/0234670 A1
(43) Pub. Date: Sep. 17, 2009

(54) Benefits Coordinating Patient Kiosk

(76) Inventor: Steven J. Larsen, Cross Plains, WI (US)

Correspondence Address: QUARLES & BRADY LLP, 411 E. WISCONSIN AVENUE, SUITE 2040, MILWAUKEE, WI, 53202-4497, US

(21) Appl. No.: 12/047,836

(22) Filed: Mar. 13, 2008

(51) Int. Cl. G06Q 50/00

(52) U.S. Cl. 705/2

(57) ABSTRACT

A method and apparatus for selecting and confirming payors for patient activities at a medical facility where the method includes providing a kiosk type interface at the medical facility for use by patients and presenting a series of questions to a patient to obtain information usable by a processor to identify and confirm payors for activities at the facility.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to patient kiosks and more specifically to a check in kiosk that selects one or more of several different payors for payment for activities at a medical facility as a function of information provided by a patient.

It is known to provide kiosks at entryways to or throughout medical facilities that allow patients to perform various functions such as checking in for appointments. As part of a check in process, it is known to provide kiosks that enable a patient to provide insurance information to facilitate benefits payments for completed activities. To this end, at least some known kiosks are equipped with insurance card readers (e.g., optical scanners, magnetic strip readers, etc.) that can be used to obtain insurance information or are programmed to guide patients through manual entry of insurance related information. Once insurance information is obtained, in some cases the insurance information is simply stored and used subsequently to obtain payment for activities performed. In other cases obtained insurance information is compared to benefits information stored by an insurer, at a medical facility, etc., and benefits (i.e., the fact that a patient at least has a policy with a specific insurer) are at least confirmed prior to completing a kiosk based check in process.

One advantage to kiosk based systems is that such systems can replace at least some facility personnel (e.g., receptionists) by moving check in responsibilities to patients. Moving responsibilities from facility personnel to patients not only reduces facility costs but can reduce information input errors. In addition, in at least some cases kiosk based check in systems can facilitate other useful activities such as providing suggestions to patients regarding other activities that can be performed during a visit, suggesting other activities that should be scheduled for appointments and enabling appointments to be made.

While kiosk systems have proven useful in many applications, one shortcoming with known kiosk systems is that the systems are not good at obtaining information needed to make correct decisions regarding coordination of benefits programs. For instance, assume that a first patient works for the ABC company and that a small chip of metal from a milling machine at the ABC company has become lodged in the first patient's left eye and that the first patient goes to St. Mary's Hospital for treatment. In addition assume that the ABC company has a worker's compensation insurance policy with ACME Insurance Company to cover on the job injuries like the one suffered by the first patient. Moreover, assume that the first patient is personally covered by an insurance policy issued by the NSA Insurance Company. Furthermore, assume that a pharmaceutical company INGA has an agreement with St. Mary's Hospital to pay for patient use of a new eye drop product having a steroid that will be useful in treating the injury sustained by the first patient and for two follow-up visits related thereto.

In the above example there are at least three possible payors for various costs associated with the first patient's visit to St. Mary's related to the eye injury including the ACME Insurance Company, the NSA Insurance Company and the INGA pharmaceutical company. In addition, a fourth possible payor or partial payor may be the first patient himself in the event that none of the other possible payors will pay for visit related activities or in the event of a co-pay requirement.

To deal with benefits coordination medical facilities and potential benefits payors have developed relatively complex rules usable to determine which entity will pay for what activities or costs associated therewith. Applying coordination of benefits rules to the above circumstances, it may be that, optimally, the INGA pharmaceutical company should pay for eye drops prescribed for the injury and for two follow-up visits and the employer's insurance company, ACME, should pay for the first visit activities and any other related visits after the second and third follow-up visits.

In known kiosk systems incorrect benefits coordination and confusion can result which can delay benefits payments and, in some case, can even result in payment rejections. To this end, in the above example known kiosks may obtain basic insurance information sufficient to confirm that the first patient has personal insurance and may check in the first patient without more. Here, the kiosk would have no way to ascertain that the first patient's injury is work related and therefore that a worker's compensation policy may provide payment for sustained injuries.

Here, instead of charging some expenses to the INGA Company and others to the ACME Company, expenses may be incorrectly charged to the first patient's insurer NSA Insurance Company with a small co-pay charged directly to the patient's personal account. In this example, while the first patient may recognize that the patient's injury related expenses should be covered by a worker's compensation policy, where the kiosk does not provide the worker's compensation policy as an option, the patient may either be confused into believing that the patient's insurance should pay or may mistakenly believe that the error will be worked out later during billing. In any event, where the patient's co-pay is small or non-existent, the patient may not care very much which payor pays for facility activities as the patient is not personally responsible either way.

At least some known systems require that a back end facility employee (e.g., a billing specialist) review insurance information obtained and compare that information to information required by an associated insurer/payor to make sure that all of the information required is obtained prior to billing the activity to the insurer/payor. Here, in at least some cases, the employee may be able to redirect charges among several payors to correct incorrect benefits coordination. Nevertheless, in cases where back end employees confirm or select correct payors, by the time the back end employees are considering who should pay for specific facility activities, it is typically too late to easily obtain information needed to correctly make payor selection and, in fact, it may not even be obvious that additional information should be obtained to make proper payor selection. For instance, in the above example where there are three possible payors for the injury sustained by the first patient, based on the information collected via the kiosk, there is no way for the employee to ascertain whether or not the first patient's injury is work related and therefore whether or not a worker's compensation claim could be made.

One solution to the above problem is to allow billing specialists to directly contact patients and obtain additional information useable to identify payors for activities performed at the facilities. This solution, unfortunately, would be very expensive and would defeat much of the reason for having a check in kiosk in the first place.

Therefore, it would be advantageous to have a kiosk system that gathers information from a patient upon checking in for an appointment at a medical facility where the gathered information is then used by the system to select payors from a plurality of possible payors for activities.

These and other objects and advantages of the invention will be apparent from the description that follows and from the drawings which illustrate embodiments of the invention, and which are incorporated herein by reference.

### BRIEF SUMMARY OF THE INVENTION

It has been recognized that a kiosk can be used to obtain information from a patient that is needed to apply benefits coordination rules and that the rules can then be applied to the obtained information to select one or more payers for patient activities, and where more than one payer is identified, to divide up fee liability accordingly. In some cases after the rules are applied, payers are confirmed using policy information stored at a medical facility or via servers maintained by the payers . . . in some embodiments a facility administrator (e.g., a billing specialist) may be presented with patient entered information and/or payers and liabilities identified using the rules and the administrator may provide final authorization.

Some inventive embodiments include a system for use by a patient that participates in an activity at a medical facility, the system for coordinating patient benefits among a plurality of different possible payors including at least first and second payors other than the patient wherein each of the first and second payors are possibly responsible for payment of at least some activities associated with the patient, the system comprising a human-machine interface, a database that stores a rules based wizard program designed to elicit information from a patient needed to determine which of the at least first and second payors will pay for specific patient activities during a visit to a medical facility, a processor linked to the database and the interface, the processor running the wizard program to perform the steps of, when a patient accesses the interface: (i) presenting questions to the patient via the interface other than a question regarding the identity of a payor for a first activity at the facility, (ii) receiving answers to the questions via the interface and (iii) selecting one of the at least first and second possible payors for the first activity as a function of the answers to the questions.

In some cases the system further includes an electronic medical records database that stores, among other things, separate medical records associated with each facility patient, the processor running the wizard program to further perform the steps of obtaining identification information from the patient, accessing a medical record associated with the identified patient and selecting questions to be presented to the patient as a function of information stored in the associated medical record. In some embodiments wherein the medical record associated with a patient includes information related to an open claim and payors for activities associated with the open claim, at least one of the questions formulated to determine if the first activity is associated with at least one of the open claims.

In some cases, when the first activity is associated with at least one open claim in the medical record, the processor selects a payor by selecting the payor for activities associated with the open claim. In some cases the system further includes a processor that, after at least one payor is selected, runs a confirmation program to perform a confirmation process for establishing that the payor will likely pay for the first activity. In some cases the system further includes an administrator terminal, the confirmation process further including presenting information to an administrator via the administrator terminal and receiving a confirming input via the terminal that the selected payor will likely pay for the first activity.

In some embodiments, after confirming that the payor will pay for the first activity, the processor provides a confirming notice via the interface to inform the patient that the first activity will be paid for by the selected payor. In some cases wherein the confirmation program includes confirming via the interface that the selected payor has agreed to pay for at least some facility activities for the patient. In some cases the interface includes a kiosk located at the medical facility.

In some cases the kiosk is a check in kiosk and wherein the processor requires the payor selection step be performed prior to the patient checking in for an appointment at the facility. In some embodiments the processor is further programmed to provide confirmation to the patient via the interface that the selected payor will pay for the activity. In some embodiments the plurality of payors further includes at least a third payor that is the patient. In some cases each of the first and second payors is an insurance company.

In some cases wherein at least one of the first and second payors is a government sponsored medical payor program and wherein the step of presenting questions to the patient includes at least presenting a secondary payor form and requesting that the patient confirm that information in the form is accurate. In some embodiments at least one of the questions is formulated to ascertain relatedness of the first activity to a work related injury and, where the activity is related to a work related injury, other questions are formulated to identify information related to a worker's compensation account. In some cases wherein at least one of the questions is formulated to ascertain relatedness of the first activity to an accident and, where the activity is related to an accident, other questions are formulated to identify information related to the accident.

Some embodiments include a system for use by a patient that participates in an activity at a medical facility, the system for coordinating patient benefits among a plurality of different possible payors, the system comprising a human-machine interface, a database that stores benefits coordination rules usable to ascertain liability for fees for activities at the facility, a processor linked to the database and the interface, the processor running the wizard program to perform the steps of, when a patient accesses the interface: (i) obtaining information from the patient regarding at least one activity at the facility, and (ii) applying the benefits coordination rules to identify at least two payors other than the patient for the at least one activity at the facility.

In some embodiments the step of applying the benefits coordination rules further includes applying the rules to divide at least a portion of the fees for the at least one activity among the at least two payors. In some cases the system further includes an electronic medical records database that stores, among other things, separate medical records associated with each facility patient, the step of obtaining information from the patient including obtaining identification information from the patient, accessing a medical record associated with the patient, selecting questions to be presented to the patient as a function of information stored in the associated medical record and obtaining answers to the questions.

In some cases the system further includes a processor that, after at least two payors are selected, runs a confirmation program to perform a confirmation process for establishing that the at least two payors will likely pay for the at least one activity. In some cases the system further includes an administrator terminal, the confirmation process including presenting information to an administrator via the administrator terminal and receiving a confirming input via the terminal that the at least two payors will likely pay for the at least one activity. In some embodiments, after confirming likely payors, the processor provides a confirming notice via the interface to inform the patient that the at least one activity will be paid for by the at least first and second payors.

In some cases the interface includes a kiosk located at the medical facility. In some embodiments the kiosk is a check in kiosk and wherein the processor requires the payor identifying step be performed prior to the patient checking in for an appointment at the facility. In some embodiments each of the at least two payors is an insurance company.

Some embodiments include a method for coordinating patient benefits among a plurality of different possible payors for activities that the patient participates in at a medical facility, the method for use where there are a plurality of possible payors other than the patient wherein each of the plurality of possible payors are possibly responsible for payment of at least some activities associated with the patient, the method comprising the steps of providing a human-machine interface, providing a database that stores a rules based wizard program designed to elicit information from a patient needed to determine which of the at least first and second payors will pay for specific patient activities during a visit to a medical facility, running the wizard program to perform the steps of, when a patient accesses the interface: (i) presenting questions to the patient via the interface other than a question regarding the identity of a payor for a first activity at the facility, (ii) receiving answers to the questions via the interface and (iii) selecting one of the at least first and second possible payors for the first activity as a function of the answers to the questions.

In some cases the method further includes the steps of providing an electronic medical records database that stores, among other things, separate medical records associated with each facility patient, running the wizard program to further perform the steps of obtaining identification information from the patient, accessing a medical record associated with the identified patient and selecting questions to be presented to the patient as a function of information stored in the associated medical record.

Some embodiments include a method for coordinating patient benefits among a plurality of different possible payors for activities that a patient participates in at a medical facility, the method comprising the steps of providing a human-machine interface, providing a database that stores benefits coordination rules usable to ascertain liability for fees for activities at the facility, running a wizard program to perform the steps of, when a patient accesses the interface: (i) obtaining information from the patient regarding at least one activity at the facility and (ii) applying the benefits coordination rules to identify at least two payors other than the patient for the at least one activity at the facility.

In some embodiments the step of applying the benefits coordination rules further includes applying the rules to divide at least a portion of the fees for the at least one activity among the at least two payors.

Some cases include a method for checking a patient in for an appointment at a medical facility where the patient has a primary care physician (PCP), the method comprising the steps of providing an interface for use by the patient, providing a database including a payor rule that specifies that the patient needs a referral to be checked in for a specific activity and that stores referral information including instances of referrals, providing a processor that performs the steps of, when the patient uses the interface to attempt to check in for an activity: (i) accessing the database and determining that a referral is required for the activity that the patient is attempting the check in for, (ii) determining that no database referral corresponds with the activity that the patient is attempting to check in for and (iii) electronically transmitting a message to the patient's PCP indicating that a referral is required.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

FIG. 1 is a schematic diagram illustrating an information system including a kiosk that is consistent with at least some aspects of the present invention;

FIGS. 2A and 2B are schematics illustrating a conditioned questionnaire in table format that is consistent with at least some aspects of the present invention;

FIG. 3 is a flow chart illustrating a method for identifying possible payors for activity fees, confirming payor responsibility for fees and checking in a patient;

FIGS. 4A-4C include a flow chart illustrating a subprocess that may be substituted for a portion of the process shown in FIG. 3 for presenting a conditioned questionnaire to a patient to obtain information needed to identify possible payors and coordinate benefits payments;

FIG. 5 is a screenshot that may be presented via the display screen shown in FIG. 1 welcoming the patient to the kiosk shown in FIG. 1;

FIG. 6 is a screenshot that may be presented as part of the check-in process;

FIG. 7 is a screenshot querying about a patient's current insurance policy;

FIG. 8 is a screenshot querying about additional health insurance policies;

FIG. 9 is a screenshot for obtaining information regarding a patient's insurance policy;

FIG. 9A is a screenshot for helping a patient identify a company that provides an insurance policy;

FIG. 9B is a screenshot wherein an image of an insurance card is provided to a patient to help the patient accurately enter insurance information;

FIG. 10 is a screenshot querying about an open claim and the relationship of the open claim to a current activity;

FIG. 11 is a screenshot confirming that a patient has been checked in for an appointment;

FIG. 12 is a screenshot querying about whether or not a current activity is related to an injury sustained at a patient's place of work;

FIG. 13 is a screenshot querying a patient about a patient's employer;

FIG. 14 is a screenshot for obtaining information about a workplace injury;

FIG. 15 is a screenshot confirming that a patient has been checked in for an appointment;

FIG. 15 is a screenshot confirming that a worker's compensation policy will pay fees and confirming that a patient has been checked in for an appointment;

FIG. 16 is similar to FIG. 15, albeit confirming that a different employer worker's compensation policy will pay fees;

FIG. 17 is a screenshot querying about whether or not a patient knows that the patient's employer has a worker's compensation program;

FIG. 18 is a screenshot querying about patient information about an employer's worker's compensation program;

FIG. 19 is a screenshot for obtaining worker's compensation program information;

FIG. 20 is a screenshot instructing a patient to go to a receptionist to complete a check in process;

FIG. 21 is a screenshot querying about whether or not a patient's visit is related at least in part to an accident caused by someone other than the patient;

FIG. 22 is a querying about a third party insurance payor;

FIG. 23 is a screenshot querying about whether or not a patient has information about a third parties insurance policy;

FIG. 24 is a screenshot for obtaining information about a third parties insurance policy;

FIG. 25 is a screenshot confirming that a patient has been checked in for an appointment;

FIG. 26 is a screenshot querying about whether or not a patient participates in a government sponsored medical payor program;

FIG. 27 is a screenshot for obtaining information about a patient's government sponsored medical payor program;

FIG. 28 is a screenshot confirming that a patient has been checked in for an appointment;

FIG. 29 is a flow chart illustrating a subprocess that may be substituted for various portions of the process shown in FIGS. 4A-4C;

FIG. 30A is a subprocess that may be substituted for a portion of the method shown in FIG. 4A; and

FIGS. 30B, 30C, 30d and 30E are similar to FIG. 30A, albeit being substituted for other portions of the method shown in FIGS. 4A-4C.

### DETAILED DESCRIPTION OF THE INVENTION

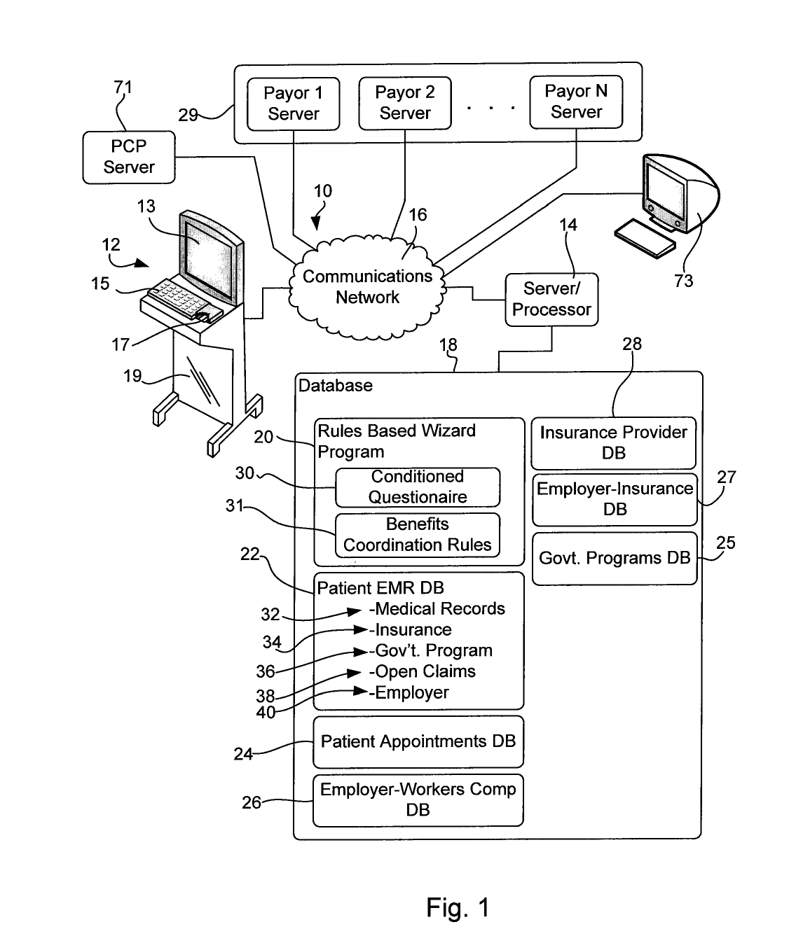

Refer now to the drawings where in like reference numerals correspond to similar elements throughout the several views and, more specifically, referring to FIG. 1, the present invention will be described in a context of an exemplary information system 10 including, among other things, a kiosk 12, a facility server/processor 14, a plurality of payor servers collectively identified by numeral 29, an administrator terminal/workstation 73, a communications network 16 and a database 18. In general, a patient can use kiosk 12 to check in for an appointment at a facility. Here, server 14 runs software to provide screen shots via kiosk that are designed to walk the patient through the check in process. According to at least some aspects of the present invention a portion of the check in process calls for server 14 to provide questions to the patient designed to obtain information about possible payers for services to be performed and that is required to select one or more payers and divide fees among the payers pursuant to benefits coordination rules. In at least some cases at least some of the coordination rules are codified in the questions presented to the patient while in other cases the values are applied after two or more possible payers for services have been selected.

Referring still to FIG. 1, kiosk 12 includes a display or screen 13, one or more input devices such as keyboard 15, a kiosk support structure identified by numeral 19 and, although not illustrated, a kiosk processor computer that may be housed within support structure 19. Although only one kiosk is shown in FIG. 1, it is contemplated that many kiosks may be provided within a medical facility or the like to facilitate patient check-in at various locations within the facility. For example, where a medical facility includes several different departments, two or three kiosks may be provided proximate each department enabling multiple patients to check-in for appointments or to perform other processes associated with medical records for the facility at one time.

Keyboard 15 or other input devices are used by a patient to provide input to system 10. Display or screen 13 is used to provide feedback or output to the patient at the kiosk 12. Herein it will be assumed that keyboard 15 or some other input device is usable to select screen displayed icons for selecting different kiosk supported functions/features. In other embodiments the display screen 13 may also operate as an input device where a patient or other user can select functions or input information via touching the front surface of the display screen. In some embodiments the processor or computer associated with kiosk 12 simply performs input and output functions and most inventive processing is performed by a server/processor 14. In other embodiments, the kiosk processor or computer may perform some steps in inventive processes while server/processor 14 performs other steps.

Referring still to FIG. 1, in addition to including the components described above, in at least some embodiments kiosk 12 may also include a card reader 17. Here, in some embodiments where patients are issued medical or patient identification cards, reader 17 may be equipped to read patient identification information from a card inserted into a slot of the reader 17 to facilitate patient identification. In addition, in at least some embodiments, reader 17 may have optical character recognition capabilities so that the reader can obtain other information regarding insurance carrier, policy type, policy number, etc., information from an inserted card.

In addition to being equipped to read a patient identification card, in at least some embodiments, card reader 17 may also be equipped to obtain credit card information from a credit card inserted into the reader slot for identification purposes and/or for payment of co-pays or the like. Moreover, in at least some embodiments reader 17 may include a scanner for scanning or creating an image of a patients insurance card when the card is inserted into the reader slot. Although only one card reader 17 is shown, in at least some embodiments more than one card reader may be provided for facilitating each of the different card reader or scanning functions described above.

Referring still to FIG. 1, in at least some embodiments server/processor 14 is located at an associated medical facility or at one medical facility associated with a plurality of other medical facilities. Server 14 is linked via communication network 16 to kiosk 12 and to other kiosks (not illustrated) located throughout an associated medical facility. In at least some embodiments, network 16 will be a local area network or a wide area network and in other embodiments network 16 may include the Internet or some type of Ethernet network. Other network types are contemplated. In addition to being linked to the kiosks 12, server 14 is also linked to database 18.

Referring yet again to FIG. 1, database 18 stores programs run by server 14 as well as the plurality of sub-databases. In addition to storing other programs, database 18 stores a rules based wizard program 20 that causes server 14 to perform methods or processes that are consistent with at least some aspects of the present invention. Sub-databases included within database 18 include a patient electronic medical record (EMR) database 22, a patient appointments database 24, an employer-worker's compensation database 26, an insurance provider database 28, an employer-insurance database 27 and a government programs database 25.

The wizard program includes a conditioned questionnaire 30 as well as a set of benefits coordination rules 31. As described in more detail below, the conditioned questionnaire 30, as the label implies, includes code that causes server 14 to present a plurality of questions to a patient via display screen 13 so that server 14 can receive information from the patient via keyboard 15 or the like where the received information can be used by server 14 to coordinate possible payors for services rendered at the medical facility. The benefits coordination rules 31 are applied by the server 14 to the information received by the patient and, in at least some cases, additional information that is stored in the sub-databases 22, 24, 26 and 28 that comprise database 18, to coordinate benefits.

Referring again to FIG. 1 the EMR database 22 includes, among other information, for each facility patient, medical records 32 associated with the patient, patient insurance information 34, information 36 regarding whether or not the patient participates in a government sponsored medical payor program (GSMPP) such as a government health insurance program, open claims information 38 and information 40 regarding a patient's employer. The open claims information 38 indicates any prior patient activity at the facility for which a payor has already been identified that new activities may be associated with and for which the payor of the previous activity will likely be responsible. For example, if a patient previously suffered a work related injury and worker's compensation paid for previous facility activities related thereto and other activities are likely to be associated therewith in the future, the worker's compensation claim, in at least some cases, would remain open and the open status would be indicated in the open claims information 38.

Referring still to FIG. 1, the patient appointments database 24, as the label implies, stores patient appointments at the facility. Employer-worker's compensation database 26 stores the names of known employers of facility patients and worker's compensation information associated therewith. For example, where ABC company has a worker's compensation insurance policy with ACME Insurance Company to cover various types of work related injuries for employees, that information would be stored generally in database 26.

Employer-insurance database 27, similarly, stores the names of known employers and insurance companies that provide policies that the employer makes available to employees. For example, where the ABC company gives employees three options for different types of insurance with three different companies, the insurance companies in the three policy options would be correlated with the ABC company in database 27.

Insurance provider database 28, as the label implies, lists all known insurance providers (e.g., insurance companies), different policies provided by the different insurance providers and benefits and constraints associated with each one of those policies. Government programs database 25 lists all known government payor programs, requirements for participating in those programs and limitations on those programs.

Referring again to FIG. 1, payor servers 29 are linked to network 16 and include a separate server for each of the possible fee payors. For instance, each insurance company may have its own server, a government payor entity may have its own payor server, and so on. In at least some embodiments each payor server maintains accounts for each patient insured by or participating in a payor program offered by the entity that runs the server. Each patient account includes information about the patient and specifies coverage that the entity (e.g., insurance company, government payor program, etc.) offers. In addition, in at least some embodiments benefits coordination rules may be maintained by each payor on their server which can be used instead of or to supplement the coordination rules 31 maintained in database 20. In some cases it is contemplated that whenever a payor updates benefits coordination rules on its server, those updates may be provided to facility server 14 so that server 14 can update its rules 31.

Administrator terminal 73 is a workstation typically located at a medical facility that is useable by a facility employee, typically a billing specialist, to, in at least some embodiments, participate in a payor confirmation process. Terminal 73 is linked to network 16.

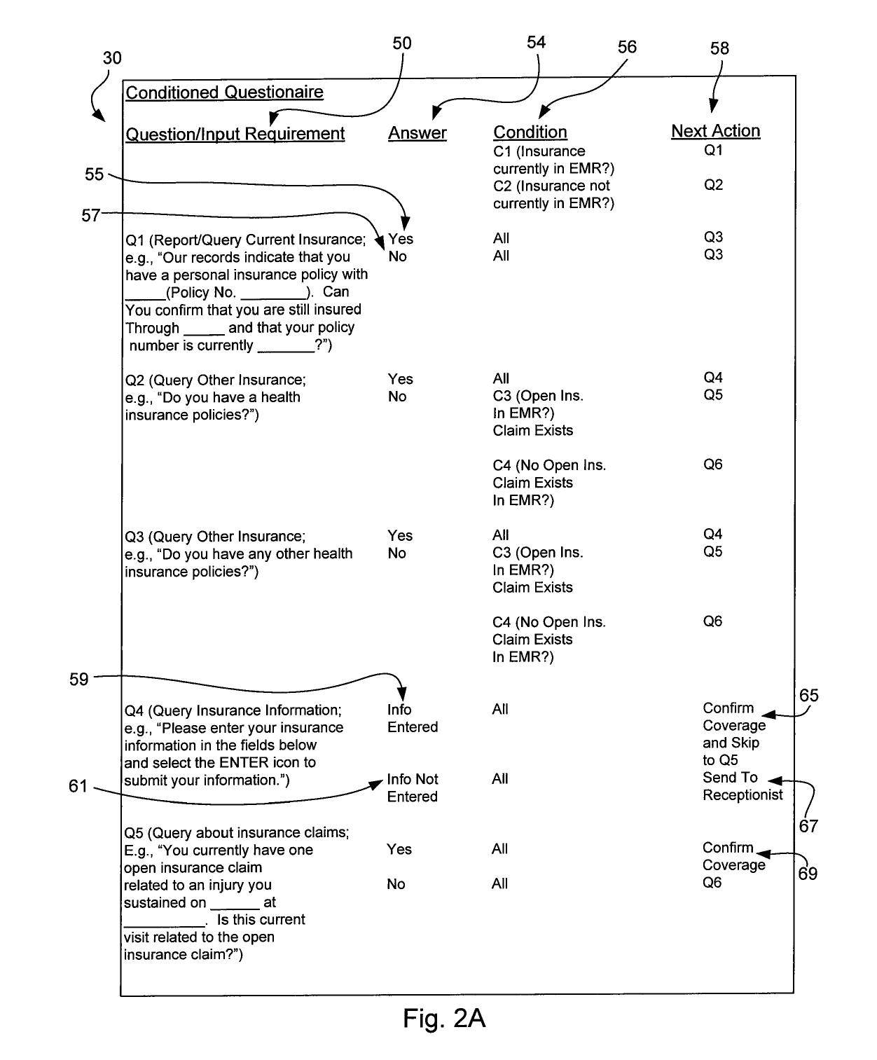

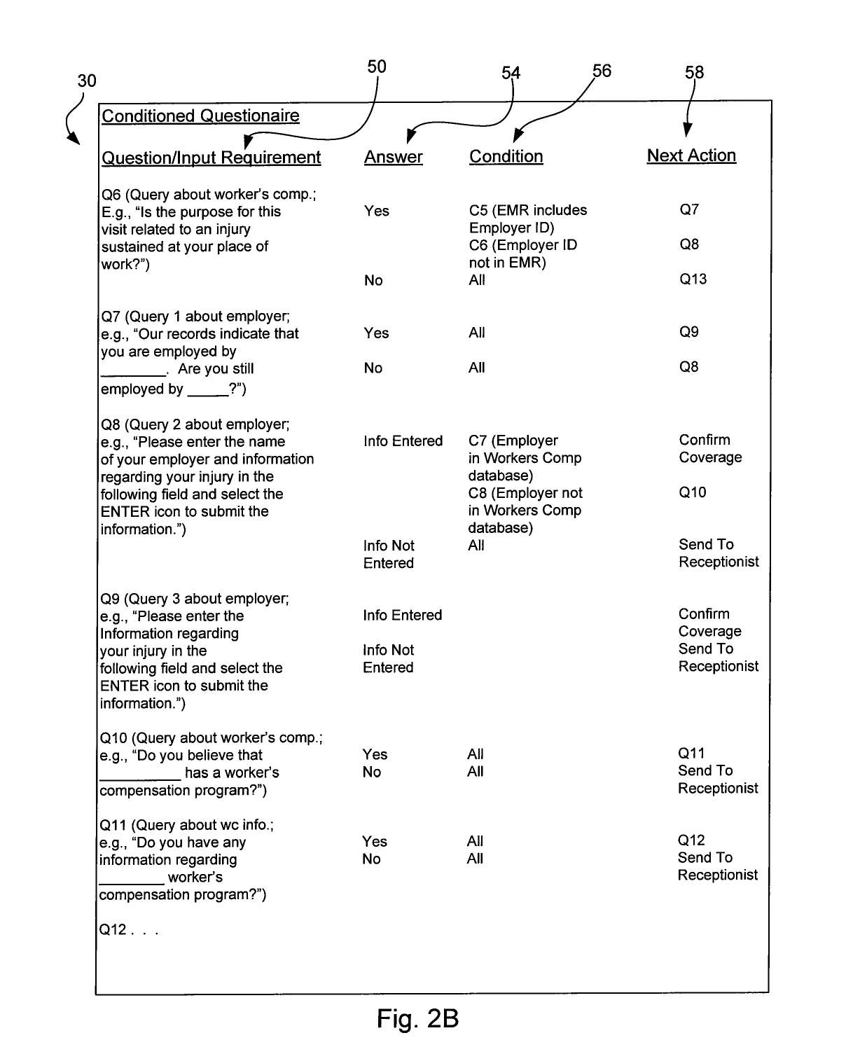

Referring now to FIGS. 2A and 2B, a schematic illustrating an exemplary conditioned questionnaire 30 that may be provided as part of the rules based wizard program 20 of FIG. 1 is illustrated. While the conditioned questionnaire would be codified in program code, the questionnaire 30 is shown in FIGS. 2A and 2B in a table format including a question/input requirements column 50, an answer column 54, a condition column 56 and a next action column 58. The question/input requirement column 50 lists a plurality of questions or input requirements Q1, Q2, Q3, etc., that, in the illustrated embodiment, are presented to a patient via display screen 13 when server 14 runs the wizard program. For example, the exemplary question Q1 queries about a patient's current insurance while exemplary question Q6 queries about a possible worker's compensation claim.

Answer column 54 lists possible answers to the questions presented in column 50. For example, for the current insurance query Q1, exemplary answers in column 54 include “YES” and “NO” 55 and 57, respectively. Other exemplary answers include generic categorizations of answers such as “info entered” (see 59) and “info not entered” (see 61).

Condition column 56 includes at least one condition for each answer in column 54 where the conditions relate to information stored in the sub-databases that comprise database 18 and are used to select next actions from column 58 for the server 14 to perform. For example, exemplary conditions C1 in column 56 causes server 14 to consider whether or not insurance information (see 34 in FIG. 1) is currently stored for a specific patient in the patient EMR database 22.

Next action column 58 lists a specific action performed by server 14 for each combination of an answer and a condition in columns 54 and 56. For example, the next action in column 58 when insurance information is currently stored in the EMR database 22 in FIG. 1 (i.e., condition C1 has been met) is to present question Q1 from question/input requirement column 50. Similarly, when insurance information for a specific patient is not currently stored in the patient's EMR database 22 (i.e., condition C2 has been met), the next action in column 58 specifies that server 14 should present question Q2 from question/input column 50.

Referring still to column 56 in FIG. 2A, another exemplary conditions include, when a patient indicates that the patient does not have a health insurance policy (see negative answer in column 54 to question Q2 in column 50), whether or not an open insurance claim exists (see 38 in FIG. 1) in the patient EMR database 22 (see first instance of conditions C3 and C4 in column 56). According to the next action column 58, when an open insurance claim does exist in the EMR database 22 (see condition C3 in column 56), server 14 presents question Q5 from column 50 and, when there is no open insurance claim for the patient in the EMR database 22 (see condition C4 in column 56), server 14 presents question Q6 from column 50. Question Q5 follows up on the open insurance claim while question Q6 queries about a possible worker's compensation claim.

Referring still to FIG. 2B, another exemplary condition is whether or not information about a patient's employer is stored in the EMR database (see 40 in FIG. 1 and conditions C5 and C6 in FIG. 2B). Different questions Q7 and Q8 are presented depending on whether or not a patient's employer information is stored in the EMR database 22. Yet one more exemplary condition that results in different next actions in column 58 is whether or not a patient's employer is listed in the employer-worker's compensation database 26 (see conditions C7 and C8 in column 56 corresponding to question Q8 in column 50).

In addition to next actions in column 58 including presentation of additional queries to a patient via display 13, other next actions include causing server 14 to confirm payor coverage (see 65 in FIG. 2A) and instructing a patient to see receptionist to complete a check-in process (see 67 in FIG. 2A). In the exemplary questionnaire 30 shown in FIGS. 2A and 2B, it is contemplated that whenever information has been entered that can be used to identify and confirm a payor for activity fees, that the identified payor will be selected and the query process will be completed. Thus, for instance, in FIG. 2A, where a patient indicates that his current visit is related to an open insurance claim in response to Q5, after coverage is confirmed (see 69 in column 58), the payor of the open claim is selected to pay fees for the current visit. In other embodiments described below, even when one possible payor is identified, all or a subset of subsequent questionnaire queries may still be presented to identify other possible payors and if one or more additional possible payors are identified, coordination rules 31 (see FIG. 1) may be applied.

The wizard program 20 may whittle down the set of subsequent queries when answers to previous questions render one or more payors impossible. For example, where a government sponsored medical payor program (GSMPP) will not pay for any part of the fee that is covered by an employer's worker's compensation program, once a worker's compensation program is identified as a possible payor, queries about GSMPP participation and qualifications may be removed from the line of subsequent questioning.

In addition, in many cases payors will require a co-pay for some portion of activity fees from a patient. In FIGS. 2A and 2B, after coverage (i.e., a payor) is confirmed (e.g., see 69), in at least some embodiments the process of obtaining the co-pay from a patient or obtaining authorization to charge the co-pay to the patient would be performed.

Referring still to FIGS. 2A and 2B, while a small subset of exemplary questions, answers, conditions and actions have been described and are illustrated, it should be appreciated that, in at least some embodiments, far more sophisticated questions and contingent next actions may be supported by the wizard program 20.

In order to appreciate the value of the present inventions, it is instructive to consider an exemplary patient encounter with system 10. To this end, hereinafter it will be assumed that a patient named Jim Johnson (hereinafter “patient Johnson”) has an appointment with Dr. Joe at 9:00 A.M. to address an eye injury that patient Johnson sustained recently.

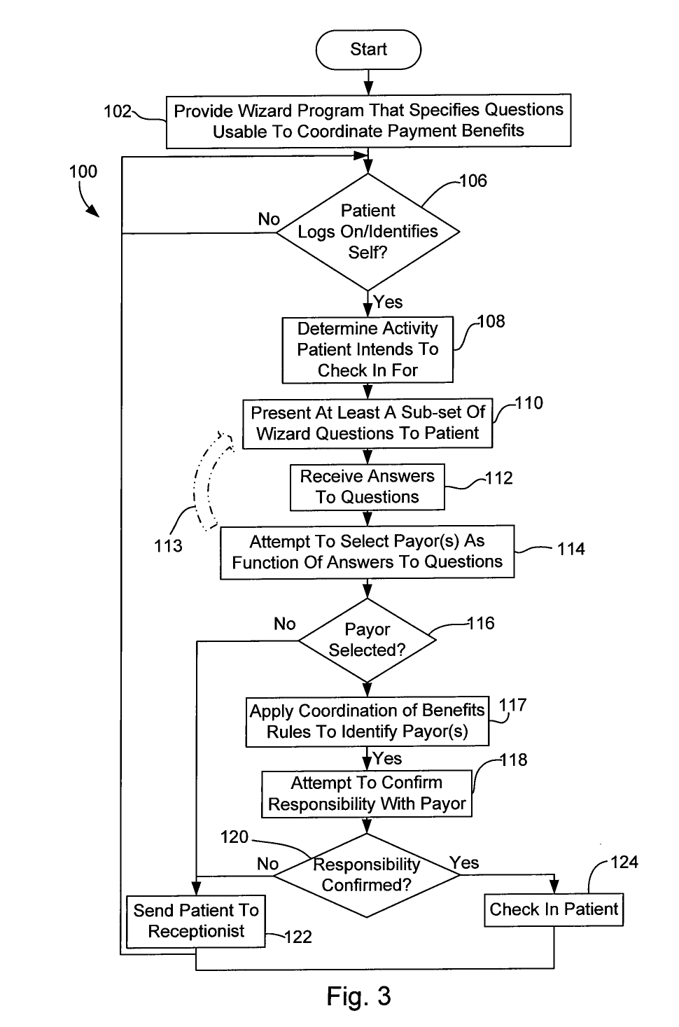

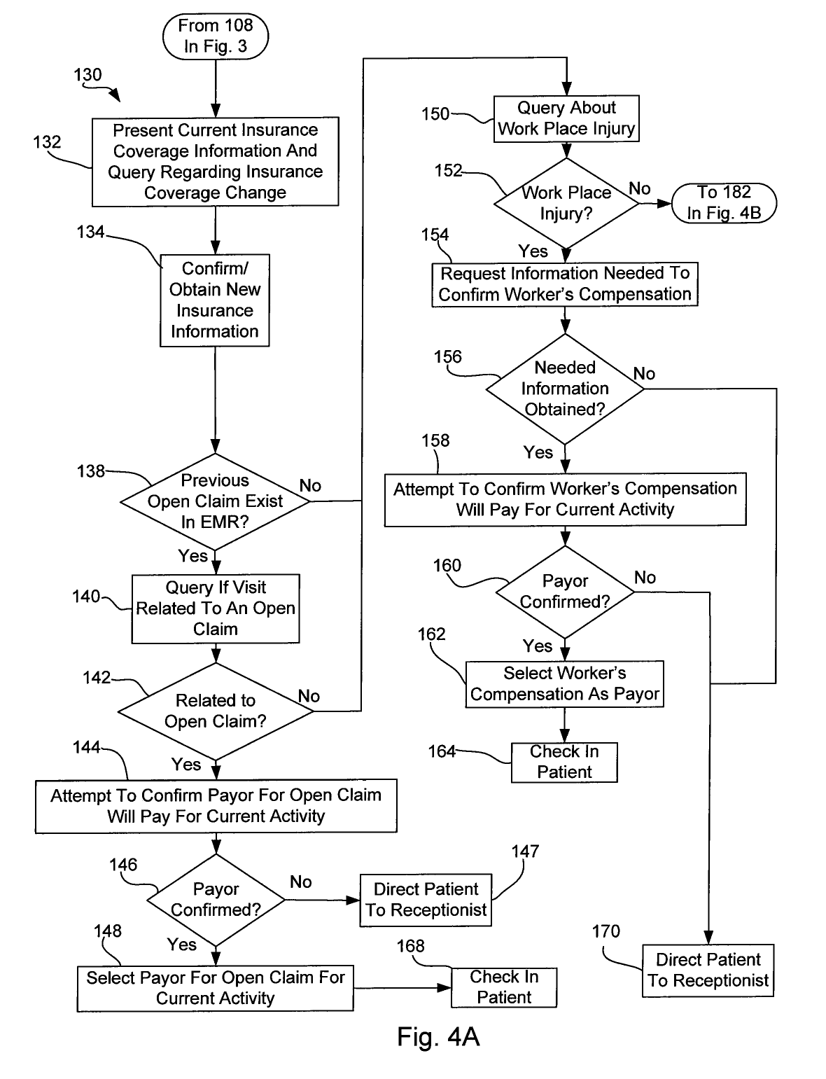

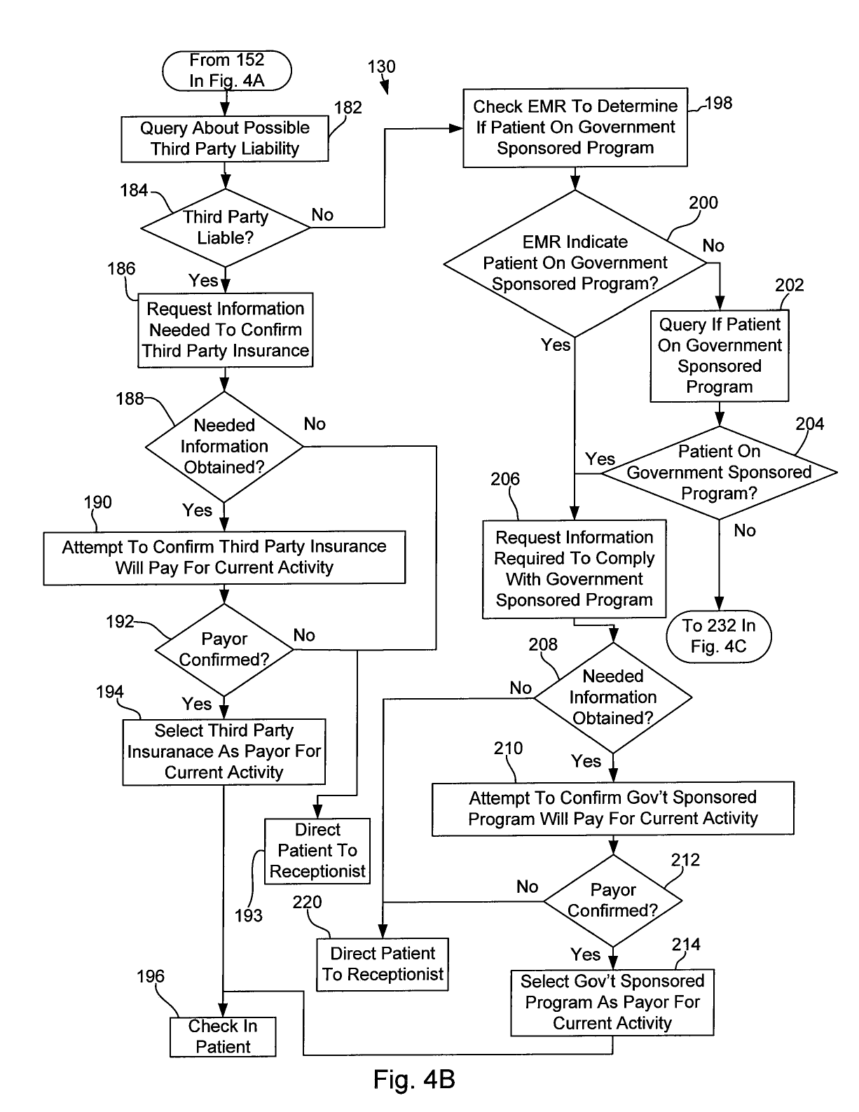

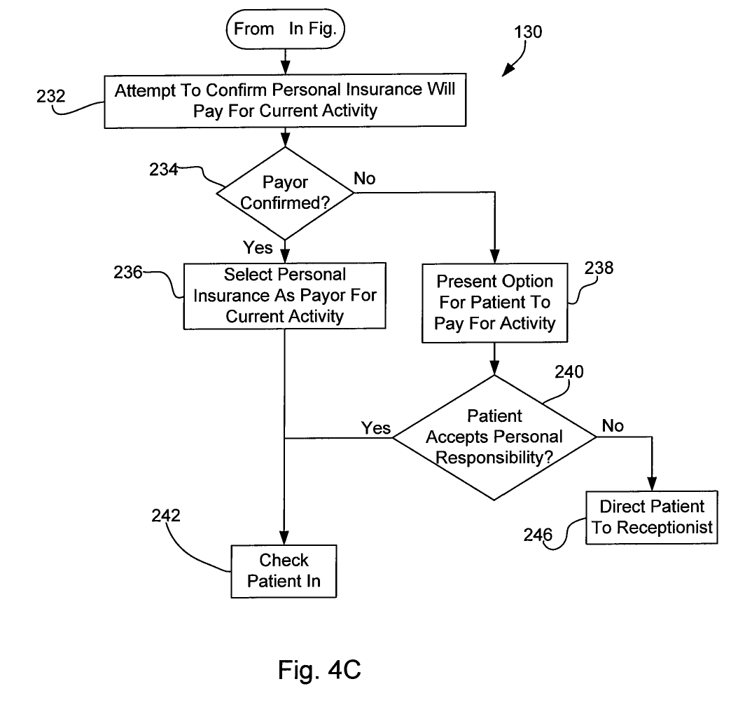

In the discussion that follows, the example will be described at a high level with reference to FIGS. 3, 5 and 6. Thereafter, a portion of the high level process for presenting a conditioned questionnaire, receiving answers and selecting a single payor will be described with reference to FIGS. 4A through 4C. Next, a more detailed explanation of an exemplary query, answer and payor selection process will be described with reference to FIGS. 1, 2A, 2B and 7-30.

In the example that follows, whenever patient Johnson provides information indicating that an entity may be liable for specific fees and either information needed to confirm that liability cannot be obtained from the patient or liability cannot be confirmed for some other reason, the patient is instructed to see a receptionist to complete the check-in process. In other embodiments where a payor cannot be confirmed, the patient may be given the opportunity to continue the kiosk check-in process in an effort to identify another possible payor.

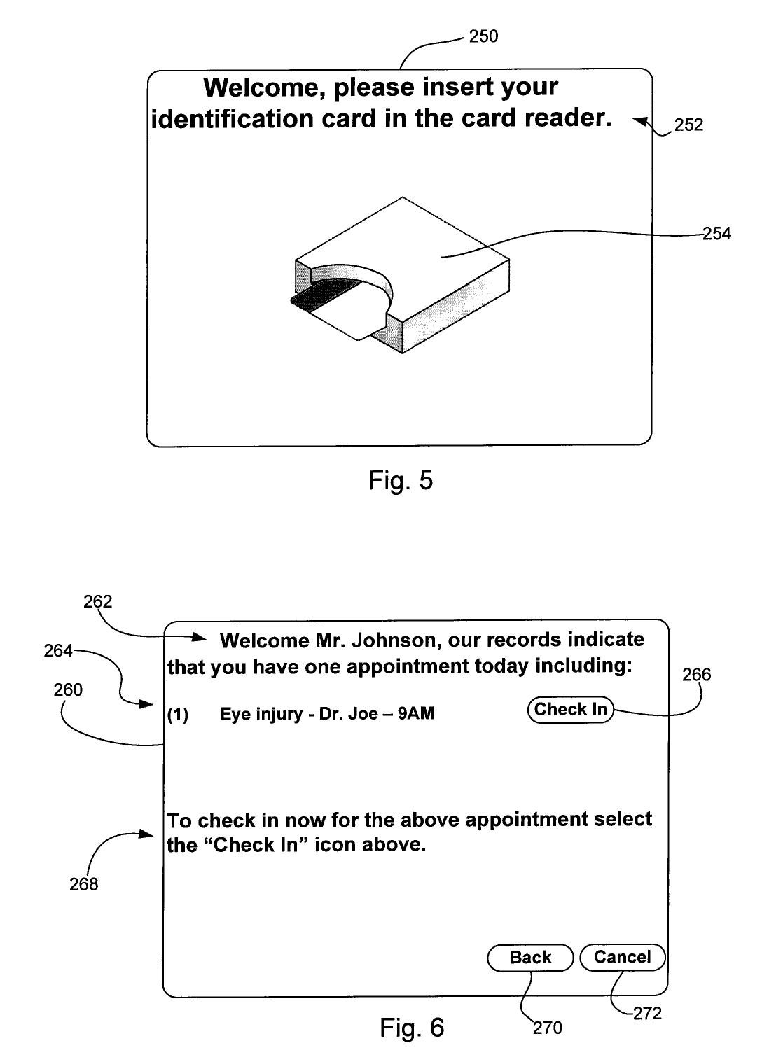

Referring now to FIG. 3, an exemplary method 100 that is consistent with at least some aspects of the present invention is illustrated where patient Johnson uses kiosk 12 (see again FIG. 1) to check in for his 9:00 a.m. appointment. To this end, at block 102, the wizard program including the condition questionnaire and the benefits coordination rules 30 and 31, respectively, are provided within database 18. Referring also to FIG. 5, at block 106, patient Johnson approaches kiosk 12 and is greeted via a screen shot 250 that welcomes 252 patient Johnson to the medical facility and requests that patient Johnson identify himself.

In FIG. 5, the method of identifying patient Johnson is via the card reader 17 in FIG. 1, an image of 254 of which is presented via a screen shot 252. In response to the prompt 252, patient Johnson inserts a patient identification card into card reader 17 which is read to identify patient Johnson. In the alternative, in at least some embodiments, a patient may use keyboard 15 or the like to provide a user name and password for identification purposes.

After a patient has properly identified himself at block 106 in FIG. 3, control passes to block 108. At block 108, information is presented via display screen 13 prompting patient Johnson to identify the activity he intends to check-in for. To this end, after a patient is identified at block 106, server 14 may access patient appointments database 24 (see again FIG. 1) and determine whether or not the patient identified has a future appointment temporally proximate the current time. Where the patient has one or more appointments that are temporally proximate the current time, server 14 may present information via display screen 13 identifying the temporally proximate appointment or appointments and querying whether or not the patient would like to check in for one or more of the identified appointments.

Referring to FIG. 6, an exemplary screen shot 260 is illustrated that may be presented via display screen 13 to query patient Johnson about activities that patient Johnson would like to check in for. Screen shot 216 includes information 262 and 264 identifying temporally proximate appointments for patient Johnson, a CHECK-IN icon 266 that can be selected via a mouse controlled or keyboard controlled cursor or the like for selecting the temporally proximate activity 264 and instructions 268 regarding how to select the icon 266 for checking in for the specific appointment 264. In addition, screen shot 260 includes a BACK icon and a CANCEL icon 270 and 272, respectively, that can be selected to move back in the sequence of screen shots to a previous screen and to cancel the check-in process, respectively. Icons 270 and 272 are provided on other screen shots to be described hereafter and operate in a similar fashion to move back in a sequence of screen shots and to cancel a check-in process in those instances.

Referring still to FIGS. 1 and 3, after patient Johnson identifies the activity for which patient Johnson would like to check-in for a block 108, control passes to block 110 where server 14 presents a subset of the conditioned questionnaire questions to the patient via display screen 13. At block 112, answers to the questions are received and at block 114, server 14 attempts to select one or more payors for the activity to occur at the medical facility as a function of the answers to the questions. In FIG. 3, arrow 113 is provided to indicate that the steps 110,112 and 114 maybe iterative wherein, after answers are provided to questions and after one or more attempts to select one or more payors as a function of answers to the questions, control may pass back up to the question presentation block 110 where other questions may be asked and where questions are selected as a function of answers to previous questions (i.e., the questioning process may be iterated where questions presented are a function of answers received).

Referring yet again to FIGS. 1 and 3, at block 116, server 14 determines whether or not a payor has been selected as a function of the answers to the questions. Where server 14 has been unable to select a payor as a function of answers to the questions presented, control passes to block 122 where server 14 instructs the patient via display screen 13 to see a receptionist to complete the check-in process. Thus, when a payor cannot be selected as a function of answers to the posed questions, a patient is always instructed to see a receptionist to complete the process. At block 116, where server 14 has selected one or more payors, control passes to block 117 where server 14 applies the benefits coordination rules (see 31 in FIG. 1) to identify which of the possible payors should be responsible for fees for activities.

At block 118 server 14 attempts to confirm responsibility for payment of fees associated with the activity to be performed with the payor. Here, confirmation may include linking a payers server (see 29 in FIG. 1) via the internet or the like and transmitting patient and activities related information to the payer's server 29 for confirmation. The payer's server may then either confirm liability for fees for the activity or deny liability. A confirmation or denial message is transmitted back to server 14. At block 120, where fees liability cannot be confirmed by server 14, control passes to block 122 where, again, server 14 instructs the patient via display screen 13 to see a receptionist. At block 120, where fee liability is confirmed, control passes to block 124 where the patient is checked in.

Referring now to FIG. 4A through 4C, a more detailed sub-process that may be substituted for the portion of method 100 in FIG. 3 including blocks 110, 112, 114, 116, 118, 120, 122 and 124 for presenting questions, receiving answers and selecting payors for fees for activities and that is consistent with the conditioned questionnaire shown in FIGS. 2A and 2B, is illustrated. To this end, a logical sequence of queries are presented to patient Johnson pursuant to the process of FIGS. 4A-4C wherein insurance information is initially updated followed by questions regarding any open claims in the patient's EMR, whether or not the current visit is related to a work related injury and hence possibly covered by a worker's compensation policy, whether or not the current visit may be covered by a third party's insurance policy and whether or not the patient participates in a government sponsored payor or insurance type program. In the example here it is assumed that when one payor in the logical sequence is selected, the query process is halted. Thus, for instance, where a worker's compensation policy will cover a fee, the policy is automatically selected as the payor and check in can be completed. In other embodiments the process of identifying possible payors may continue to attempt to identify other possible payors after which benefits coordination rules 31 are applied to select final payors.

Referring also to FIGS. 1, 2A, 2B and 3, after the activity for which a patient intends to check-in for is identified at block 108, control may pass to block 132 in FIG. 4A. At block 132, server 14 presents insurance information currently stored in the EMR database 22 and queries patient Johnson regarding accuracy of the information. Where the insurance information in the EMR database is accurate, control passes to block 138. Where the information in the EMR database is not accurate, control passes to block 136 where server 14 controls kiosk 12 to present information to patient Johnson designed to obtain the new insurance information from patient Johnson. The new insurance information is then stored in the patient EMR database 22. After block 136, control passes to block 138 where server 14 determines whether or not there are any open insurance claims 38 in EMR database 22. Where no open insurance claims exist, control passes from block 138 to block 150 to next query about a work place injury. However, where an open insurance claim does exist, control passes to block 140.

Referring still to FIGS. 1 and 4A, at block 140, server 14 provides queries to patient Johnson via display screen 13 to determine whether or not a current visit is related to one of the open insurance claims. At block 142, when the current visit is not related to an open insurance claim, control passes to block 150. However, at block 142, where patient Johnson indicates that the current visit is related to an open claim, control passes to block 144 where server 14 attempts to confirm that the payor for the previous related activity will pay for the current activity. To this end, the process of attempting to confirm the payor at block 144 may be as simple as determining whether or not all of the funds allocated for a previous claim have been used up or if remaining funds for a previous claim will cover the activity to be performed at the facility. Other more sophisticated ways of confirming that a payor for previous related activities will pay for a current activity are contemplated.

At block 146, where server 14 cannot confirm that the payor for the previous related activity will pay for the current activity, control passes to block 147 where server 14 provides a message to patient Johnson via display screen 13 indicating that patient Johnson should go see a receptionist to complete the check in process. At block 146, where server 14 determines that the payor for the previous related activity will pay for the current activity, control passes to block 148 where server 14 selects the previous payor for the current activity and then to block 168 where patient Johnson is checked in.

Referring still FIGS. 1 and 4A, at block 150, server 14 provides questions to patient Johnson via display screen 13 to determine whether or not the activity for which patient Johnson is checking in for is related to a workplace injury. At block 152, where the activity is not related to a workplace injury, control passes to block 182 in FIG. 4B. However, where the activity is related to a workplace injury, control passes to block 154 where server 14 requests information from patient Johnson needed to confirm a worker's compensation claim. At block 156, where the needed information to confirm a worker's compensation claim is not obtained for some reason (e.g., patient Johnson does not have or know the required information or submits inaccurate information), control passes to block 170 where patient Johnson is instructed to go see a receptionist to complete the check-in process. However, at block 156, where the needed information is obtained, control passes to block 158 where server 14 uses the obtained information to attempt to confirm that a worker's compensation policy or program will pay for the current activity.

At block 160, where server 14 cannot confirm that a worker's compensation policy will cover the current activity, control again passes to block 170 where patient Johnson is instructed to see a receptionist to complete the check-in process. At block 160, where the server confirms that the worker's compensation policy will cover the current activity, control passes to block 162 where server 14 selects the worker's compensation policy as the payor for the activity. At block 164 patient check-in is completed.

Referring once again to FIG. 1 and now also to FIG. 4B, at block 182, server 14 queries patient Johnson about possible third party liability for the activity for which patient Johnson intends to check-in. At block 184, where patient Johnson indicates that there is no possibility of third party liability, control passes to block 198. Where patient Johnson indicates that there is a possibility of third party liability, control passes to block 186 where server 14 requests information from patient Johnson needed to confirm third party liability and third party insurance. At block 188, where the information needed to confirm third party liability and insurance cannot be obtained, control passes to block 193 where patient Johnson is instructed to see a receptionist to complete the check-in process.

At block 188, where the information needed is obtained, control passes to block 190 where server 14 uses the obtained information to attempt to confirm third party insurance will pay for the current activity. At block 192, where server 14 cannot confirm that a third party insurance policy will cover the current activity, control passes to block 193 where patient Johnson is again instructed to see a receptionist to complete the check-in process. Where server 14 does confirm that a third party insurance policy will cover the current activity, control passes to block 194 where the third party insurance is selected as the payor for the current activity. Thereafter, at block 196 the check-in process is completed.

Referring still to FIGS. 1 and 4B, at block 198 server 14 checks the EMR database 22 to determine whether or not patient Johnson participates in a government sponsored medical insurance type program. At block 200 where the EMR database indicates that the patient does participate in a government sponsored program, control passes to block 206 where server 14 requests information from patient Johnson to comply with the government sponsored program.

At block 200, where the EMR database does not indicate that patient Johnson participates in a government sponsored program, control passes to block 202 where server 14 queries patient Johnson about government sponsored program participation. At block 204, where patient Johnson indicates that he does not participate in a government sponsored program, control passes to block 232 in FIG. 4C. Where patient Johnson indicates that he does participate in a government sponsored program at block 204, control passes to block 206 where server 14 again requests information required to comply with the government sponsored program.

At block 208, server 14 determines whether or not the needed information to comply with the government sponsored program has been obtained. Where the needed information has not been obtained, control passes to block 220 where patient Johnson is instructed to see a receptionist to complete the check-in process. At block 208, where the needed information is obtained, server 14 uses the obtained information to attempt to confirm that the government sponsored program will pay for the current activity. At block 212, where server 14 cannot confirm that a government sponsored program will pay for the current activity, control passes to block 220 and patient Johnson is instructed to see a receptionist to complete the check-in process. Where server 14 does confirm that the government sponsored program will pay for the current activity at block 212, control passes to block 214 where server 10 selects the government sponsored program as the payor for current activity.

Referring still to FIG. 1 and now to FIG. 4C, at block 232, server 14 uses personal insurance information 34 stored in EMR database 22 to attempt to confirm that patient Johnson's personal insurance policy will pay for the current activity. At block 234, where server 14 cannot confirm that the personal insurance policy will cover the current activity, control passes to block 238 where an option is presented to patient Johnson to allow patient Johnson to pay for the current activity. At block 240, when patient Johnson does not agree to pay for the current activity, control passes to block 246 where patient Johnson is instructed to see a receptionist to complete the check-in process. Where patient Johnson does accept personal responsibility for payment at block 240, control passes to block 242 where the check-in process is completed. Referring once again to block 234, where server 14 determines that patient Johnson's personal insurance will pay for the current activity, control passes to block 236 where server 14 selects the personal insurance as the payor for the current activity after which control passes to block 242 where the check-in process is completed.

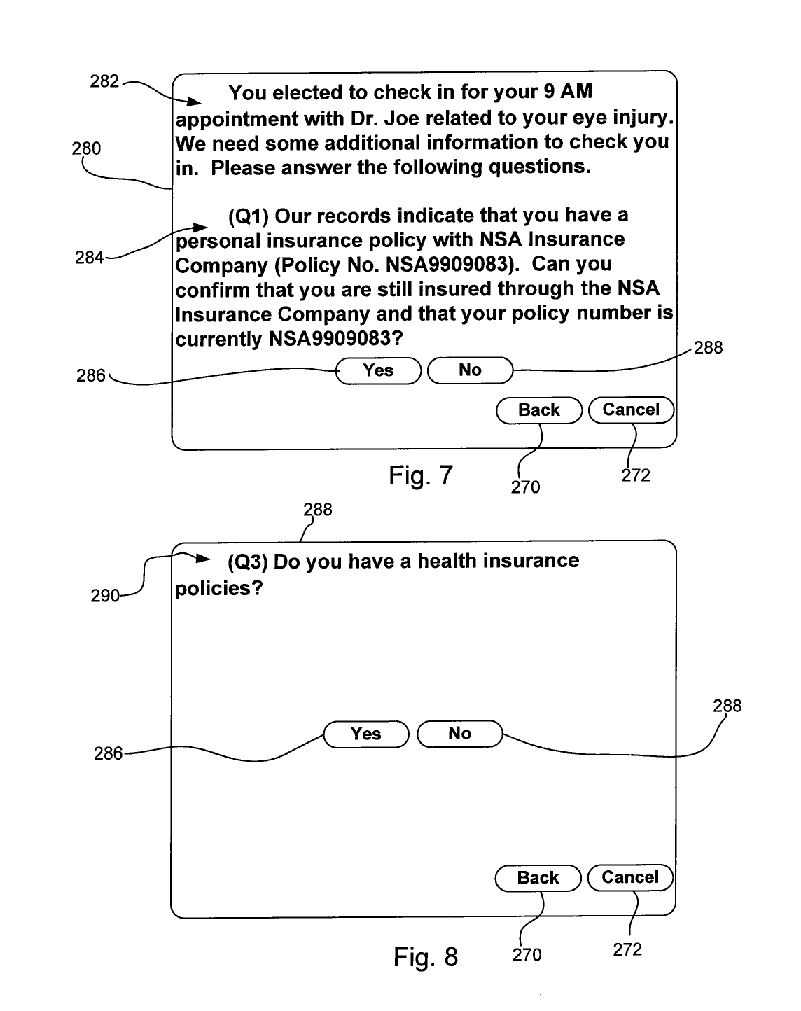

Next, a simple example of how the process shown in FIG. 4A through 4C is performed that is consistent with the conditioned questionnaire shown in FIGS. 2A and 2B is described. To this end, referring once again to FIGS. 1 and 6, after patient Johnson in the above example selects the CHECK IN icon 266 in FIG. 6 to check-in for the 9 a.m. appointment with Dr. Joe, referring also to FIG. 2A, pursuant to the conditioned questionnaire, server 14 first considers conditions C1 and C2 (i.e., whether or not the EMR database 22 in FIG. 1 stores insurance information for patient Johnson). Pursuant to FIG. 2A, where condition C1 exists (i.e., the EMR database includes insurance information for patient Johnson), the next action in column 58 is for server 14 to present question Q1. Referring also to FIG. 7, an exemplary screenshot 280 for presenting question Q1 is shown. Exemplary screenshot 280 includes a confirmation statement 282, a query statement 284 and YES and NO icons 286 and 288, respectively, that are provided to allow patient Johnson to respond to the query statement 284.

Confirmation statement 282 simply confirms patient Johnson's selection via the previous screenshot (e.g., FIG. 6 in the present example). The query statement 284 presents the first question from the question/input requirement column 50 in FIG. 2A. Here, information in some fields in the query statement Q1 may be mined from the EMR database 22 such as, for example, the company with which patient Johnson has an insurance policy, the policy number, etc. By selecting one of the icons 286 and 288 presented via shot 280, patient Johnson can respond to the query statement 284.

Referring once again to FIG. 2A, and, more specifically, to condition C2, when condition C2 is initially met (i.e., that the EMR database 22 does not include insurance information for patient Johnson), the next action in column 58 is that server 14 provide question Q2 from question/input requirement column 50. No exemplary screenshot for presenting question Q2 is provided, however, if one were provided, it would be similar to screenshot 280 and would present the question and it include answer icons akin to icon 286 and 288.

Referring once again to FIG. 2A, and, more specifically, question Q1 and related information in columns 54, 56 and 58, where patient Johnson answers YES (see 55 in FIG. 2A), in all cases, the next action in column 58 is that server 14 presents question Q3 from column 50. Thus, if patient Johnson indicates that the insurance information in the query statement 284 (see again FIG. 7) is accurate, the next question will be whether or not patient Johnson has any other health insurance policies. Similarly, where patient Johnson indicates that the information about his policy in the query statement 284 is inaccurate, the next question will still be whether or not patient Johnson has other health insurance policies(e.g., question Q3 will be asked). An exemplary screenshot 288 for presenting question Q3 is shown in FIG. 8. Screenshot 288 includes a query statement 290 that includes the question Q3 and answer icons 286 and 288.

Referring yet again to FIG. 2A, and, more specifically, to question Q2 in column 50 and the associated information in columns 54, 56 and 58, if patient Johnson answers YES to the question regarding a health insurance policy, in all case (i.e., under all conditions in column 56), the next action in column 58 is that server 14 present question Q4 via the display screen 13. As seen in FIG. 2A, question Q4 is provided to obtain additional insurance information from the patient, in the present case, patient Johnson.

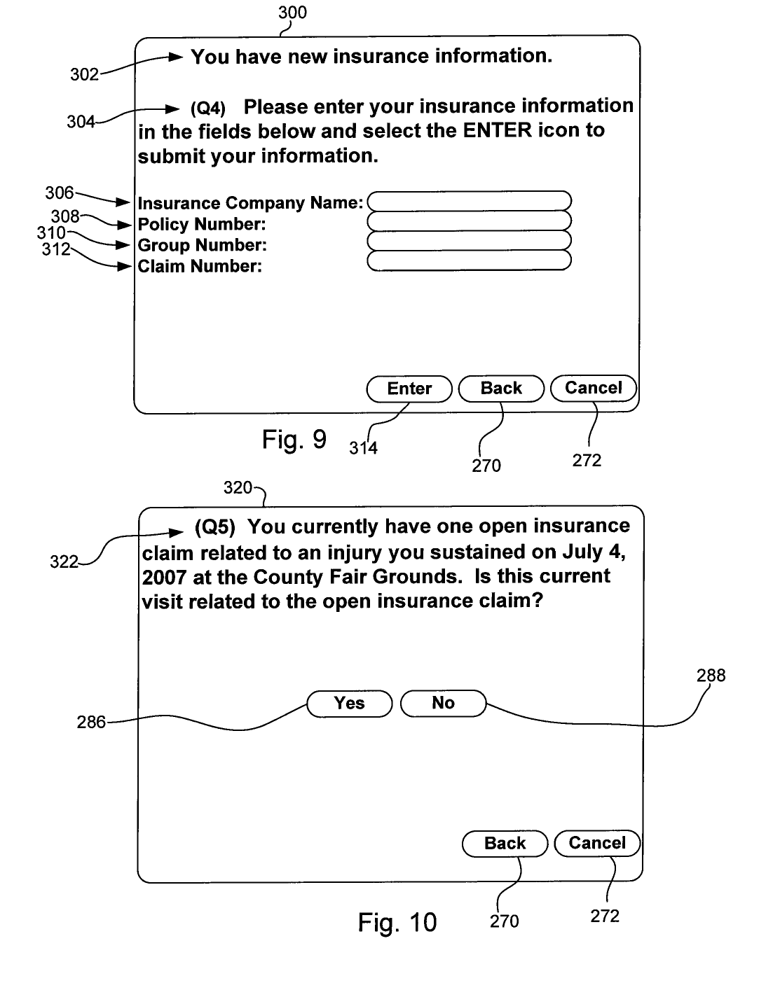

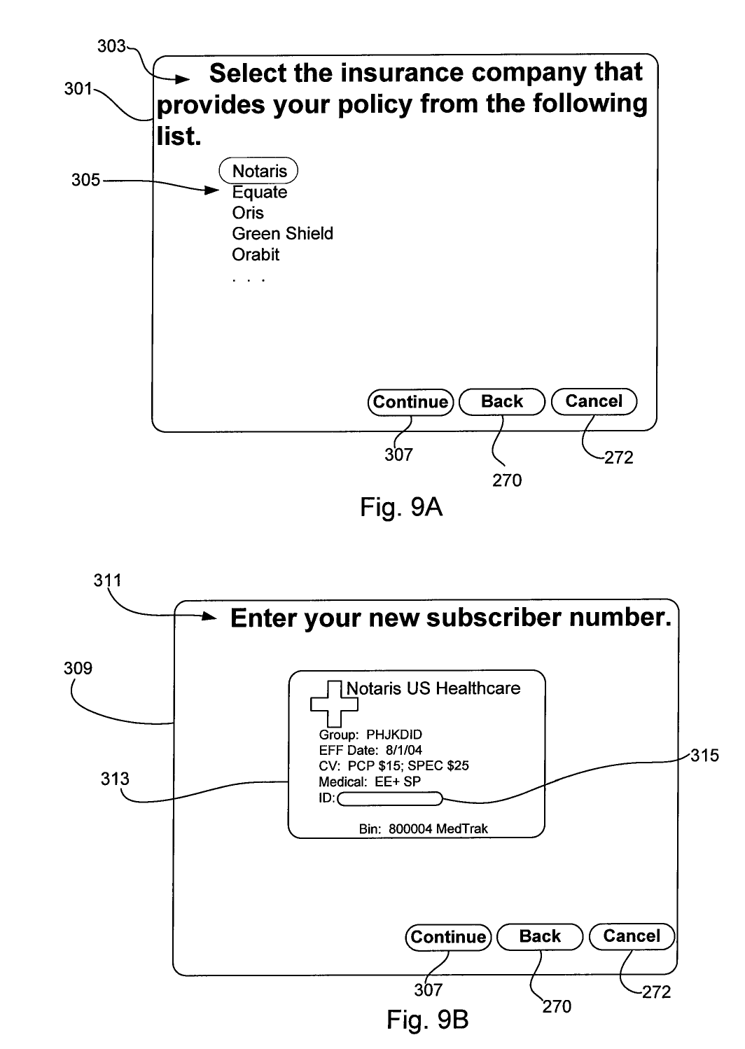

Referring to FIG. 9, an exemplary screenshot 300 for obtaining additional insurance information from a patient is illustrated. Screenshot 300 includes a confirmation statement 302 confirming that the client has indicated that the client has new or additional insurance information, query statement 304 corresponding to question Q4 and fields 306, 308, 310 and 312 for entering new insurance information including company name, policy number, group number, claim number, etc. While only a small set of fields for new information are provided in FIG. 9, it should be appreciated that, in most cases, a larger number of fields and more sophisticated fields would be contemplated. After information is entered in the fields 306, 308, 310 and 312, an ENTER icon 314 may be selected to submit the entered information.

Thus, in FIG. 2A, the questions, answers, conditions and next actions corresponding to questions Q1 through Q4 and the exemplary screenshots shown in FIGS. 7 through 9 are provided to confirm and obtain additional insurance information from a patient and hence correspond generally to blocks 132, 134 and 136 in FIG. 4A.

According to one aspect of the present invention, information stored in database 18 may be presented by server 14 to help a patient identify an insurance carrier and enter required information accurately. To this end, where information specifying an insurer and a policy are required, server 14 may present the screen shot 301 in FIG. 9A including a list 305 of known insurers from database 28 as well as instructions 303 to select one of the insurers on the list. An insurer can be selected by highlighting the insurer in the list (see Nataris) and selecting a CONTINUE icon 307.

Once an insurer has been selected, server 14 may access an image in database 28 of an exemplary insurance card for the selected insurer and present the image via a screenshot to help the patient identify required information. To this end, see screenshot 309 in FIG. 9B that includes a card image 313 and instructions 311 to enter information. Here a field box 315 is provided one field at a time corresponding to different required information and data entered via keyboard 15 or the like is entered into the field box 315. With card image 313 on screen 13, a patient can examine his insurance card and confirm that the card has an appearance similar to the image and hence that the patient selected the correct insurance carrier via the FIG. 9A screenshot. Next, the patient can match up the location of information on his card with the location of box 315 on image 313 and easily identify the required information to be entered. After a field is filled in, CONTINUE icon 307 is selected to submit the information and move on to the next field.

Referring again to FIG. 1, where reader 17 is capable of card scanning and optical character recognition, in at least some embodiments a patient may provide insurance information by simply inserting his card into reader 17 when prompted. Once the card is inserted and scanned, server 14 may automatically identify the insurance carrier that issued the card as well as policy information so that manual entry of the information is not required. Similarly, where a card includes magnetically stored insurance information reader 17 may be equipped to obtain insurance information from the card when inserted.

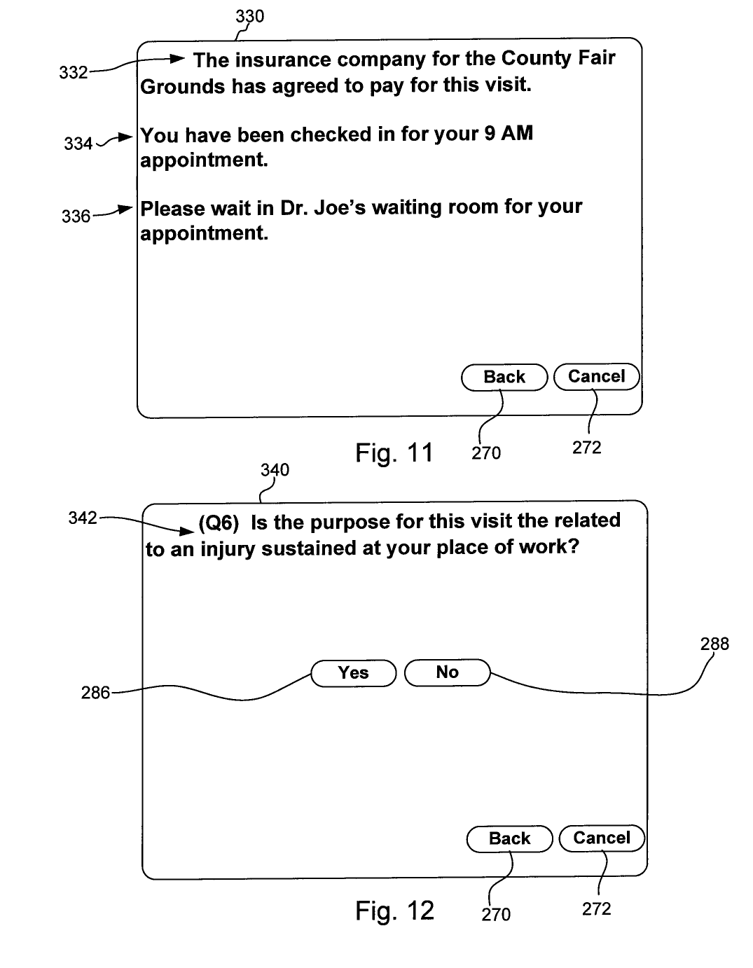

After personal insurance information has been obtained, as seen in FIG. 4A, server 14 next turns to determining whether or not outstanding insurance claims exist for previous activities. As seen in FIG. 2A, conditions C3 and C4 in column 56 deal with outstanding insurance claims and cause server 14 to present either questions Q5 or Q6 to the patient. In the present example it will be assumed that patient Johnson has one outstanding insurance claim related to an injury sustained on Jul. 4, 2007 at the County Fair grounds. In this case, because condition C3 is met, server 14 presents question Q5. An exemplary screenshot 320 for presenting question Q5 is shown in FIG. 10 where a query statement including question Q5 is shown at 322 and answer icons 286 and 288 are provided. As seen in FIG. 2A, where patient Johnson indicates that his current visit is related to the outstanding insurance claim, server 14 simply confirms coverage (see blocks 144 and 146 in FIG. 4A). In this regard, see also FIG. 11 that includes a screenshot 330 where coverage is confirmed under the open insurance claim. Screenshot 330 includes a checked-in statement 332, a confirmation statement 334 indicating that patient Johnson has been checked in for his 9 a.m. appointment and instructions 336 instructing patient Johnson to wait in a specific waiting room for the appointment.

Referring once again to FIG. 2A, where patient Johnson indicates that his current visit is not related to an outstanding insurance claim, server 14 next presents question Q6 seen in FIG. 2B. Question Q6 queries whether or not the purpose of the visit is related to an injury sustained at patient Johnson's workplace. An exemplary screenshot 340 for querying about a workplace related injury is shown in FIG. 12 and includes a query statement 342 that includes question Q6 and answer icons 286 and 288 for responding to the query. As seen in FIG. 2B, where patient Johnson answers YES to question Q6, where condition C5 is met (e.g., that the EMR database includes information indicating patient Johnson's employer), server 14 next presents question Q7. However, where patient Johnson answers YES to question Q6 and the EMR database does not include information indicating patient Johnson's employer, server next presents question Q8. Where patient Johnson indicates that the purpose of the visit is not related to any injury sustained at his place of work, in all cases, the next question presented by server 14 is question Q13 (not shown in FIG. 2B).

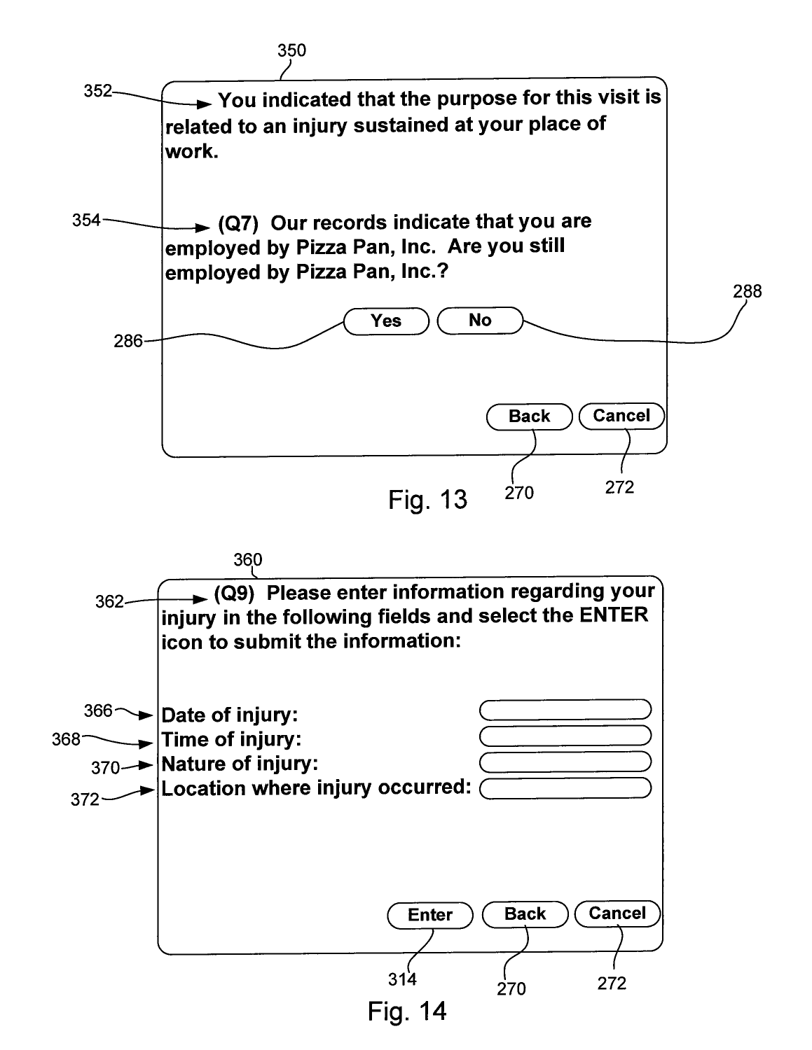

Referring yet again to FIGS. 1 and 2B, question Q7 provides employer information from the EMR database to patient Johnson and queries whether or not the employer information is still accurate. Referring also to FIG. 13, an exemplary screenshot 350 for presenting employer information is illustrated. Screenshot 350 includes a confirmation statement 352 as well as a query statement 354 that includes question Q7. Screenshot 350 also includes answer icons 286 and 288.

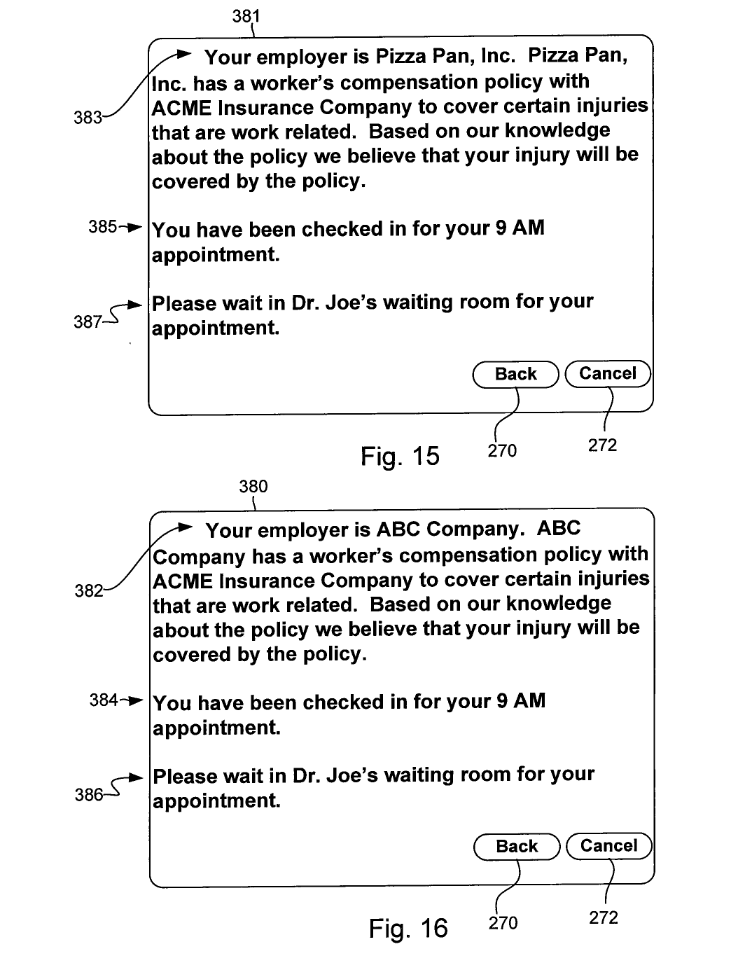

Referring still to FIG. 2B, where patient Johnson answers YES to question Q7, in all cases the next question presented by server 14 is question Q9 where server 14 requests entry of information regarding patient Johnson's injury via the display screen 13. An exemplary screenshot 360 for obtaining injury information is shown in FIG. 14. Screenshot 360 includes question statement 362 that includes question Q9 as well a fields 366, 368, 370 and 372 for entering injury related information (i.e., date, time, nature of injury, location, etc.). Other more sophisticated information is contemplated. Screenshot 360 also includes an ENTER icon 314 selectable to submit information entered via the fields thereabove. Once information is entered, if coverage is confirmed, a screenshot like the one 381 in FIG. 15 may be presented including a confirming statement 383, a checked-in statement 385 and instructions 387 on where to wait for the appointment.

Referring yet again to FIG. 2B, question Q8 is similar to question Q9 except that, in addition to requesting information regarding an injury, question Q8 requests information regarding the name of the patient's employer. Thus, a screenshot for presenting question Q8 may be similar to screenshot 360 in FIG. 14 except that it may include an additional field for entry of the name of the patient's employer.

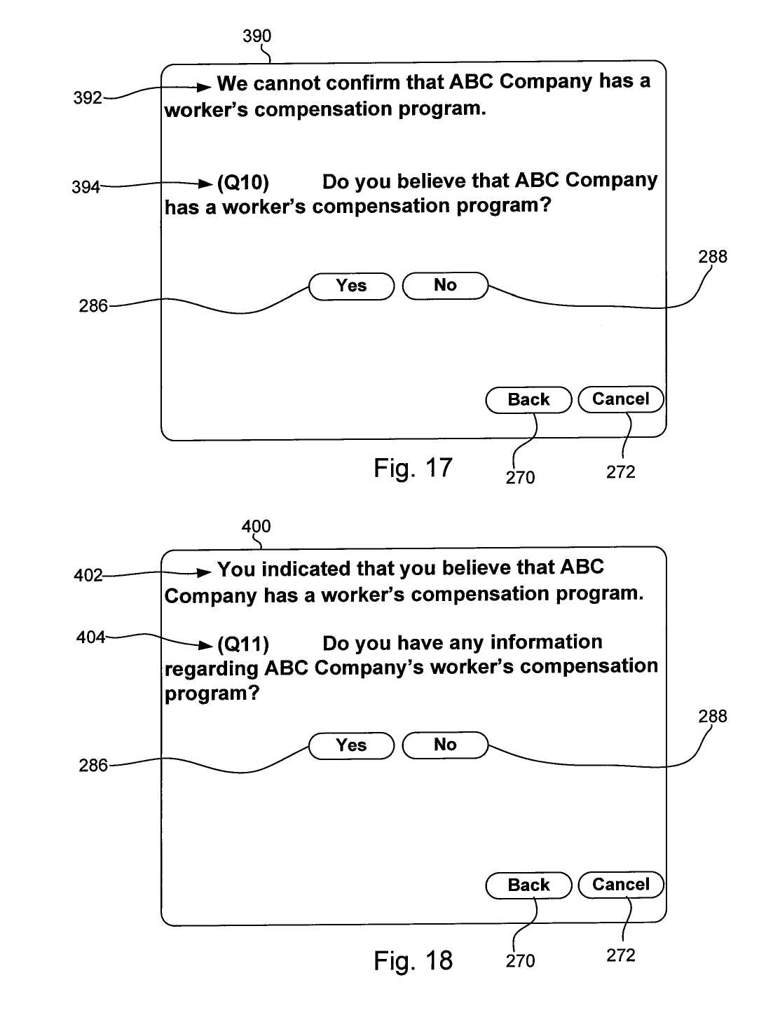

Referring again to FIG. 2B, after entry of information in response to question Q8, if information exists in the employer-worker's compensation database 26 about the patient's employer and the employer's worker's compensation policy, coverage of the activity to be performed may be confirmed. An exemplary screenshot 380 for confirming worker's compensation coverage for the activity is shown in FIG. 16. Screenshot 380 includes a coverage confirmation statement 382, a checked-in statement 384 indicating that patient Johnson has been checked-in for his 9 a.m. appointment and instructions 386 instructing patient Johnson to wait in a specific waiting room for his appointment.

Where patient Johnson's employer's worker's compensation information is not included in the database 26 after information is entered in response to question Q8, the next question presented by server 14 is question Q10 querying about patient Johnson's knowledge regarding whether or not a compensation program exists. An exemplary screenshot 390 for querying about the existence of a worker's compensation program is shown in FIG. 17. Screenshot 390 includes a confirmation statement 392 indicating that, based on the information provided, the server cannot confirm that patient Johnson's employer has a worker's compensation program. In addition, screenshot 390 includes question Q10 querying as to whether or not patient Johnson believes that his employer has a worker's compensation program as well as answer icons 286 and 288.

Referring once again to FIG. 2B, and specifically, to question Q10 and related information in columns 54, 56, and 58, where patient Johnson indicates that he does in fact believe that his employer has a worker's compensation program, the next question presented by server 14 is Q11 which is presented to obtain information regarding the compensation program. Where patient Johnson indicates that he does not believe that his employer has a worker's compensation program in response to question Q10, patient Johnson is sent to a receptionist to complete the check-in process. An exemplary screenshot 400 is shown in FIG. 18 for presenting question Q11. Screenshot 400 includes a confirmation statement confirming that patient Johnson believes that his company has a worker's compensation program, a query statement 404 including question Q11 and answer icons 286 and 288.

Referring yet again to FIGS. 2A and 2B, it should be appreciated that only a small subset of possible questions for the conditioned questionnaire are illustrated and that many other questions may be formulated and are indeed contemplated for collecting information in an intelligent manner from a patient that can then be used to identify one or more payors for facility activities. The questions, answers, conditions and next actions for the additional queries would take a logical form similar to that described and illustrated above with respect to FIGS. 2A and 2B. Additional queries and related information are not provided here in the interest of simplifying this explanation.

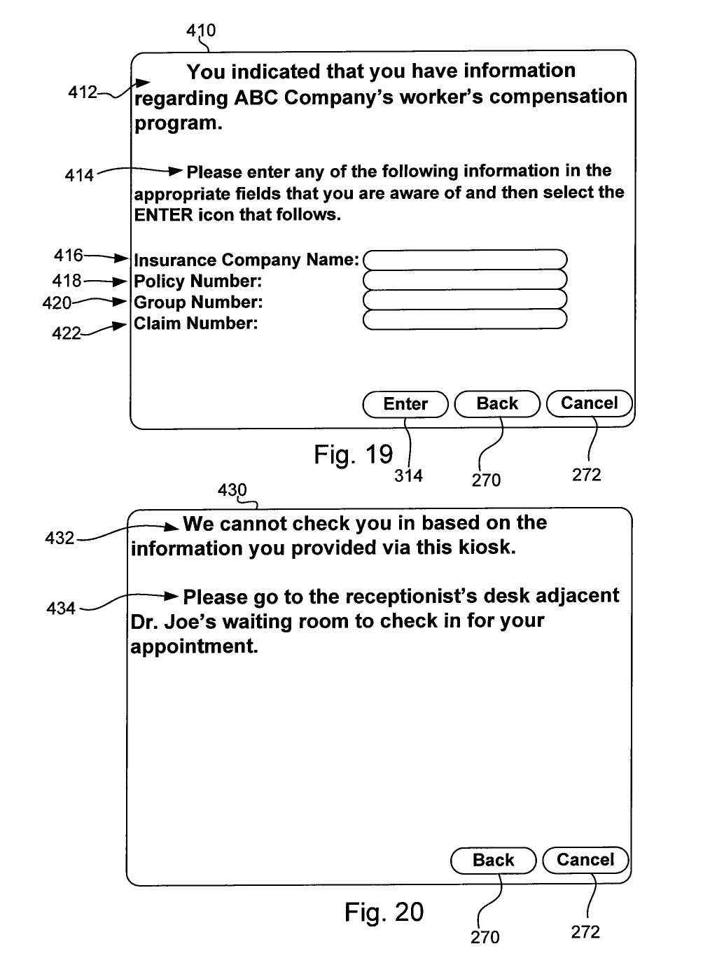

While only a portion of a conditioned questionnaire is illustrated in FIGS. 2A and 2B and is described above, it is instructive to provide additional screenshots that are consistent with at least one embodiment of the present invention to show a natural progression of the conditioned questionnaire as it may be presented to patient Johnson in the above example. To this end, referring again to FIG. 18, if patient Johnson selects the YES icon 286 to indicate that he in fact does have information regarding his company's worker compensation program, server 14 may present screenshot 410 in FIG. 19 to obtain information regarding the compensation program. Screenshot 410 includes a confirmation statement 412, query statement 414, and fields 416, 418, 420 and 422 for entering information related to patient Johnson's employer's worker's compensation program. After information is entered in the fields, an ENTER icon 314 may be selected to submit that information to server 14.

After information is submitted via screenshot 410, if that information is insufficient to identify patient Johnson's employer's worker's compensation program, screenshot 430 may be presented as shown in FIG. 20. Screenshot 430 includes a confirmation statement 432 indicating that patient Johnson cannot be checked in at the kiosk and instructions 434 indicating that patient Johnson should go to a receptionist desk to complete the check-in process.

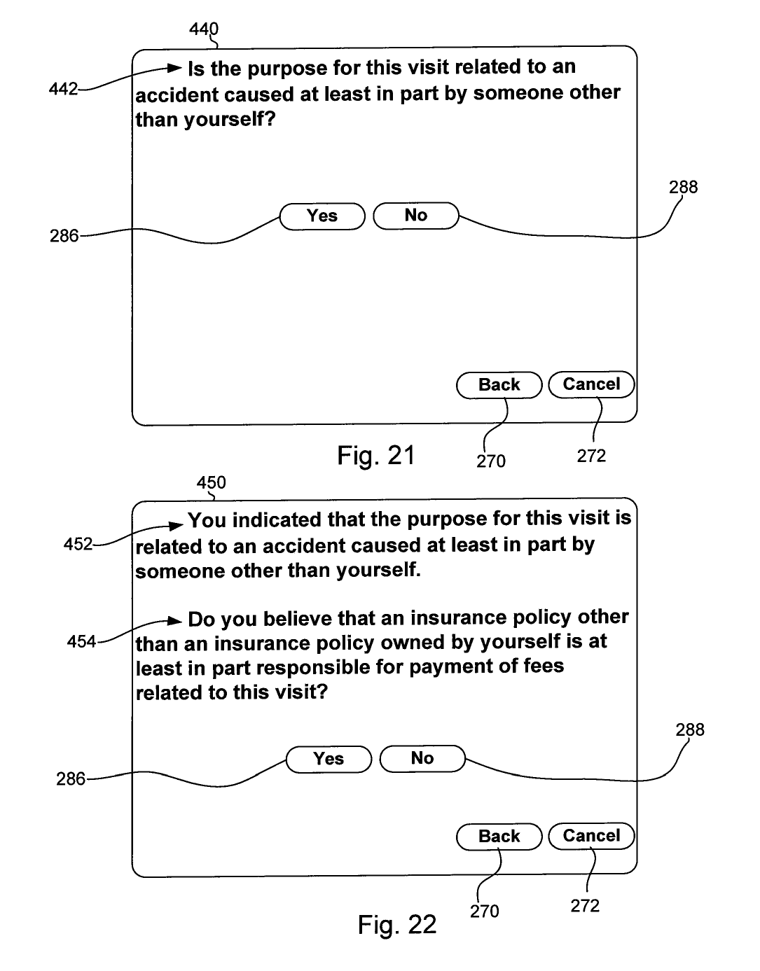

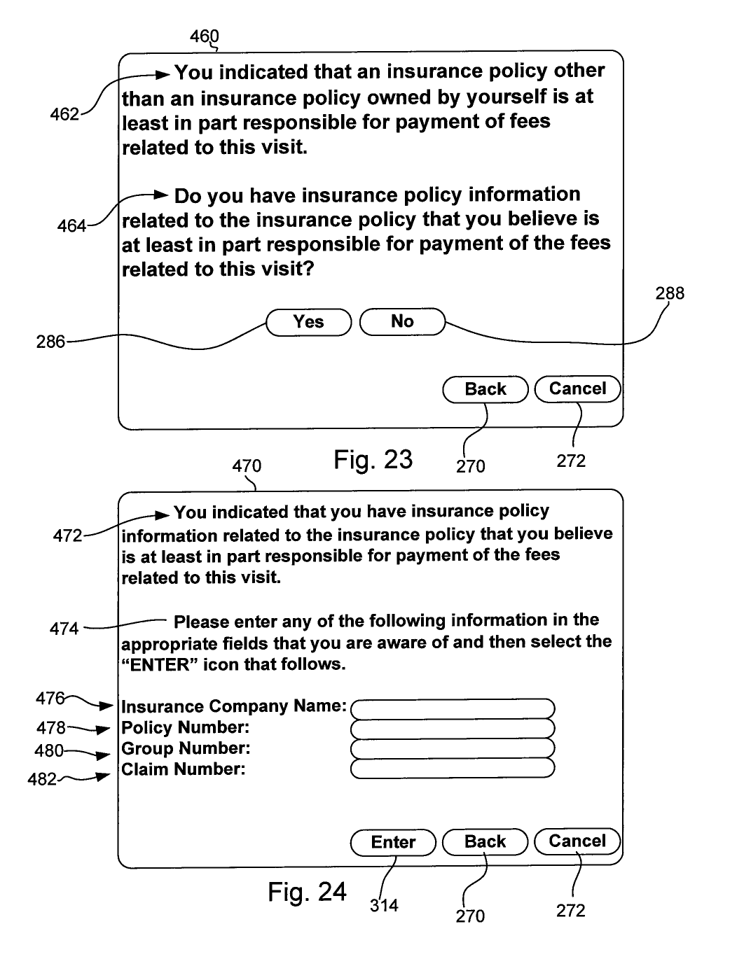

Referring again to FIG. 12, where patient Johnson indicates that the purpose of his visit is not related to an injury sustained at his place of work, server 14 may present screenshot 440 show in FIG. 21 to determine whether or not the purpose of the visit is related to an accident caused at least in part by someone other than patient Johnson (e.g., a third party). To this end, screenshot 440 includes a question statement 442 inquiring about third party liability and answer icons 286 and 288.

Where patient Johnson indicates that his visit is related to an accident caused at least in part by someone else, server 14 may present screenshot 450 shown in FIG. 22. Screenshot 450 includes a confirmation statement 452 as well as a question statement 454 where the question statement queries as to whether or not patient Johnson believes that an insurance policy other than one owned by himself is at least in part responsible for payment of fees related to the visit and answer icons 286 and 288. Where patient Johnson indicates that another insurance policy may be at least partially liable, server 14 may present screenshot 460 in FIG. 23. Screenshot 460 includes a confirmation statement 462 as well as a query statement 464 and answer icons 286 and 288. Here, query statement 464 inquires as to whether or not patient Johnson has information about the insurance policy that he believes may at least be in part responsible for payment of fees related to the current visit.

When patient Johnson has information related to an insurance policy, server 14 may present screenshot 470 in FIG. 24. Screenshot 470 includes a confirmation statement 472, a query statement 474 and fields 476, 478, 480 and 482 for entering information in response to query statement 474. Query statement 474 invites patient Johnson to enter information about the third party insurance company. Information in the fields can be submitted by selecting ENTER icon 314.

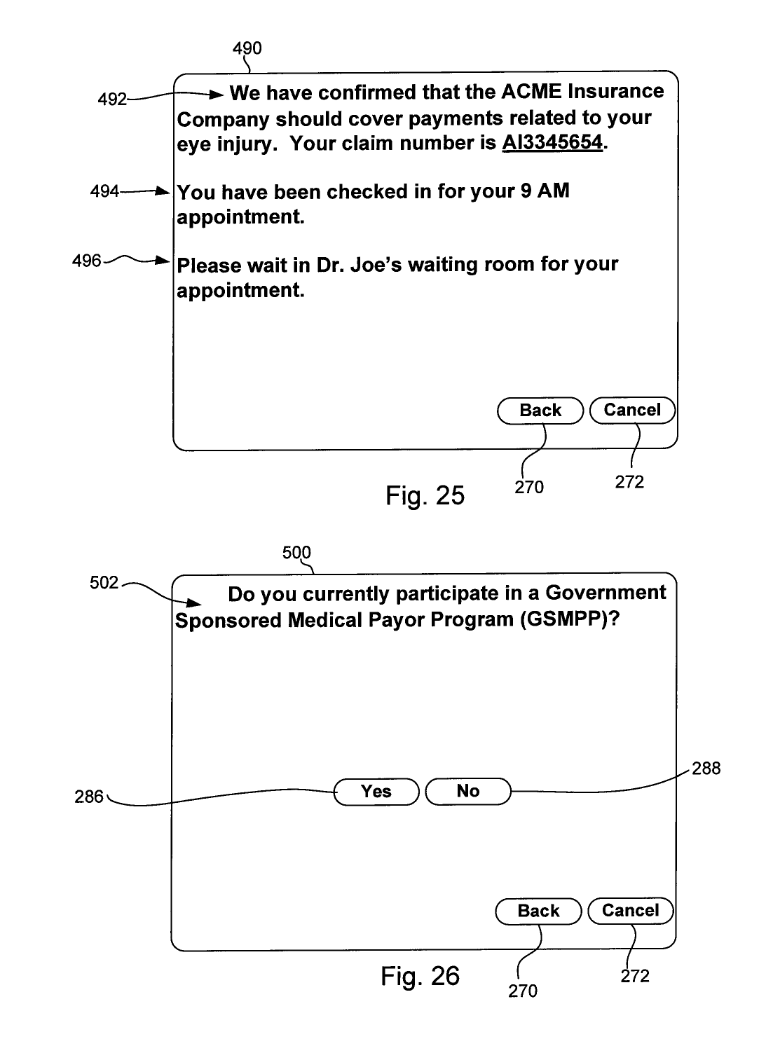

When required information has been entered about a third party's insurance policy, server 14 attempts to confirm that the insurance company will pay for the activity to be performed. After confirmation from the payor, screenshot 490 in FIG. 25 may be presented by server 14 confirming the payor. Screenshot 490 includes a confirmation statement 492, a checked-in statement 494 and waiting instructions 496 for patient Johnson.

Referring to FIGS. 23 and 24, if patient Johnson answers “no” to the query in FIG. 23 or cannot enter required information in FIG. 24, server 14 may provide instructions to patient Johnson to see a receptionist to compete the check-in process. In FIGS. 21 and 22, if patient Johnson answers no to either of the posed questions, server 14 may next present a query regarding participation in a government sponsored medical payor program (GSMPP) or the like. To this end, see exemplary screenshot 500 in FIG. 26 that includes a query 502 about GSMPP participation and answer icons 286 and 288.

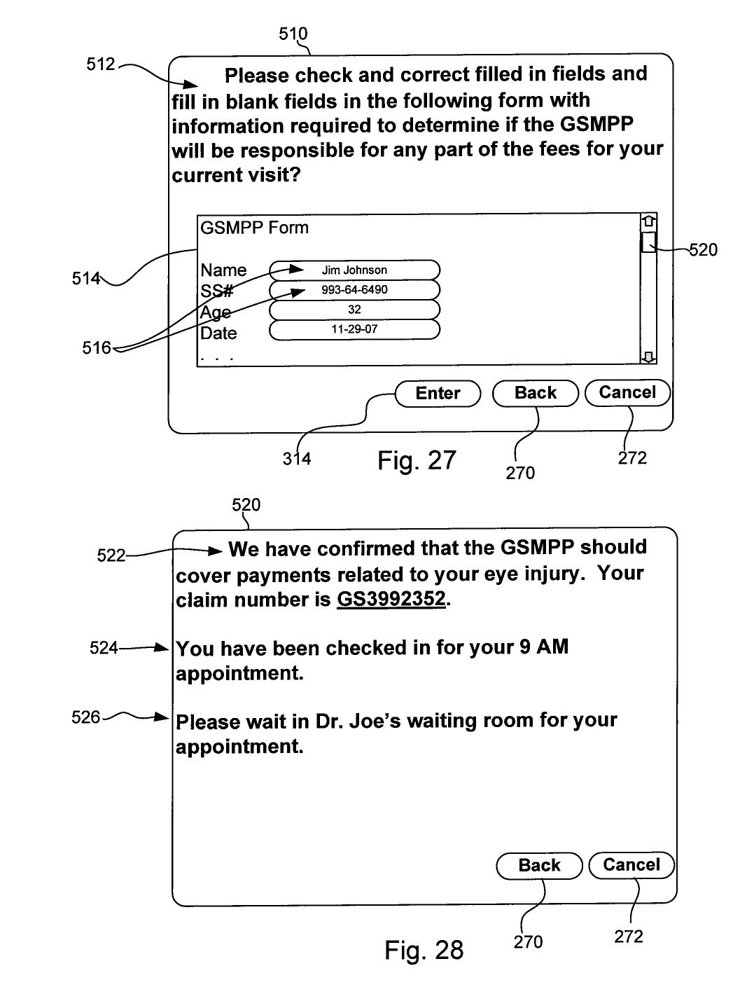

Referring still to FIG. 26, where patient Johnson indicates that he is a GSMPP participant, server 14 may present screenshot 510 in FIG. 27 to obtain information from patient Johnson about the GSMPP, to confirm participation and obtain information needed to determine fees the GSMPP will cover, if any. Here it is contemplated that in at least some cases much of the information needed to confirm participation and determine fees may already be stored in the patient's EMR generally or as a result of a previous activity covered by the GSMPP at the facility. In these cases where a GSMPP secondary payor form or fields associated therewith are presented, information may be inserted from the EMR into the fields automatically and the patient may simply have to confirm and correct the presented information. To this end, screenshot 510 includes an instruction statement 512 and a GSMPP form 514 with pre-populated fields 516 and a scrolling bar 520 for moving the form up and down to access different fields. Once form information is accurately completed patient Johnson can select ENTER icon 314 to submit the form information.

After GSMPP required information has been entered, sever 14 attempts to confirm GSMPP participation and that the GSMPP will pay for current activity fees. When confirmed, a confirmation screenshot 520 may be presented as shown in FIG. 28. Screenshot 520 includes a confirmation statement 522, a checked-in statement 524 and waiting instructions 526.

Referring again to FIG. 27, if patient Johnson cannot enter information required by the GSMPP to confirm participation and identify fees that will be paid, server 14 may instruct patient Johnson to see a receptionist to complete the check-in process. Referring to FIG. 26, if patient Johnson indicates that he does not participate in a GSMPP, server 14 may next attempt to obtain consent to charge patient Johnson directly. Screenshots for obtaining patient consent to pay are not provided here but such screenshots would be similar to those described here.

In the above examples, when a possible payor cannot be confirmed for some reason (e.g., inaccurate entry of information by a patient, mistake liability, inability to verify a policy, etc.), the patient is always instructed to see a receptionist to complete the check-in process. In at least some embodiments when a payor cannot be confirmed, a patient may be given the option to attempt to identify other possible payors using the kiosk. Here, where a patient continues to attempt to identify other payors it is advantageous as additional information is obtained from the patient and the patient may in fact be able to provide additional information useable by the server to identify a possible payor.

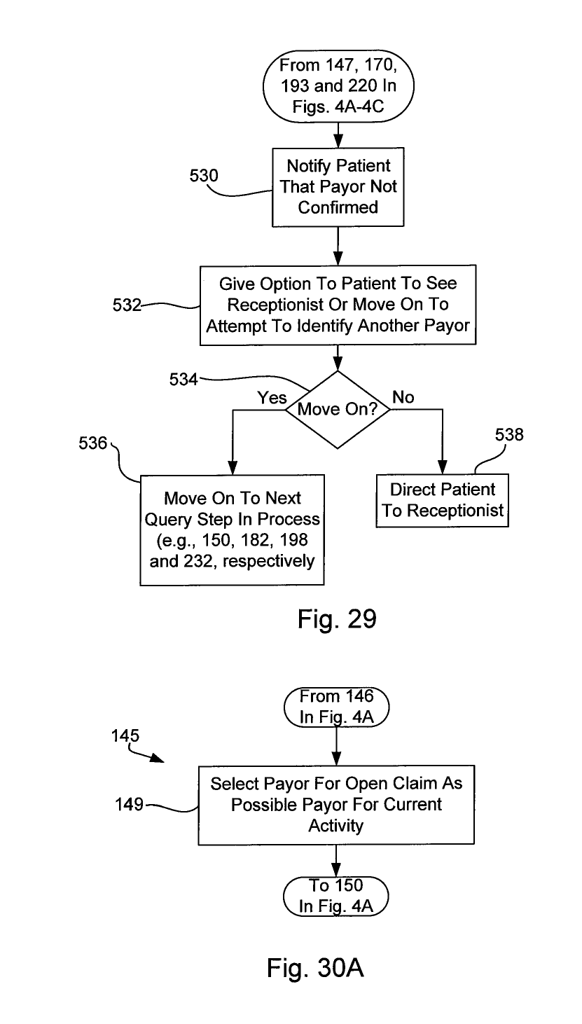

Referring to FIG. 29, a subprocess that may be substituted for the steps (see steps 147, 170, 193 and 220) in FIGS. 4A-4C that instruct a patient to see a receptionist to complete the check-in process is illustrated. At block 530, instead of instructing the patient to see a receptionist, server 14 notifies the patient via display screen 13 that specific payor (e.g., worker's compensation, a third parties insurance, an open claim payor, a GSMPP, etc.) cannot be confirmed. At block 532, server 14 gives the patient the option to see a receptionist to complete check-in or to move on at the kiosk to attempt to identify another payor. At block 534, where the patient indicates that he wants to see a receptionist control passes to block 538 where server 14 instructs the patient to see a receptionist. If the patient indicates that he wants to move on at block 534, at block 536 the process skips ahead to the next query step. Here, where the FIGS. 29 subprocess is substituted for blocks 147, 170, 193 and 220, the next query steps are 150, 182, 198 and 232, respectively.

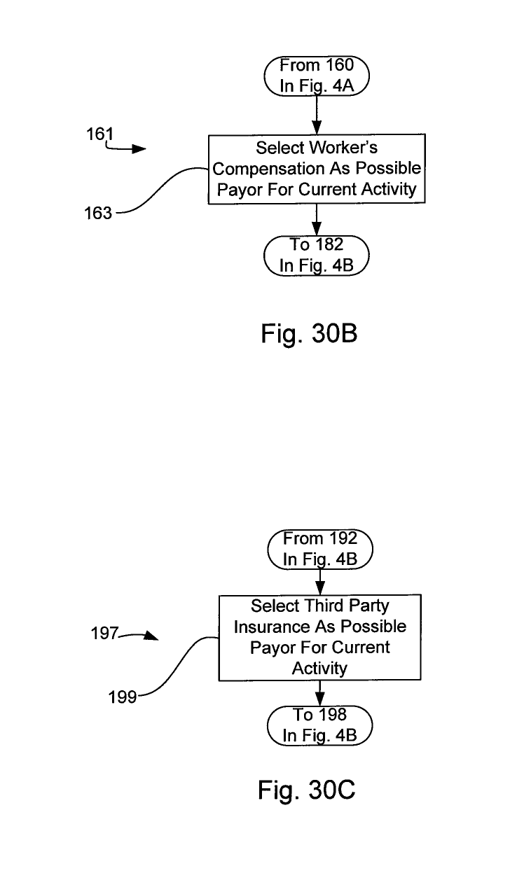

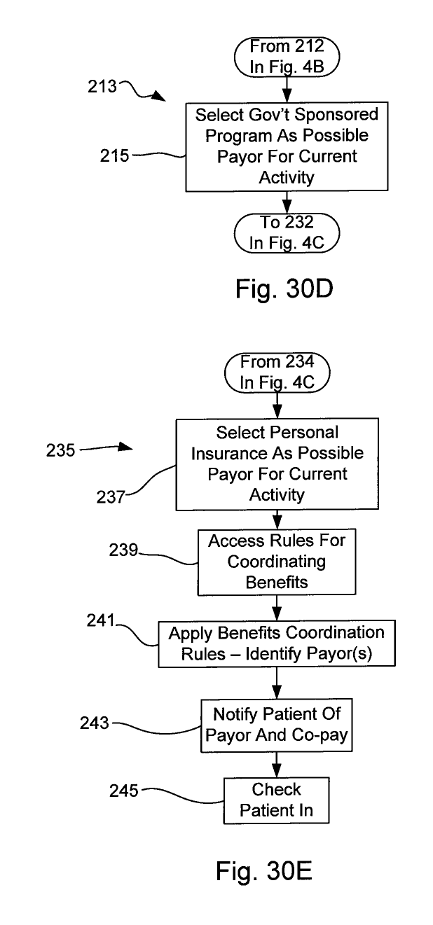

In some embodiments it is contemplated that there may be two or more payors that split activity fees pursuant to the benefits coordination rules 31. Here, instead of halting the payor query process after one possible payor is identified, it is contemplated that the query process continues until all possible payors are identified and then the coordination rules 31 are applied. To this end, subprocess 145, 161, 197, 213 and 235 that may be substituted for process steps or added to the process shown in FIGS. 4A-4C are illustrated in FIGS. 30A-30E. Referring also to FIG. 4A, where a payor of an open claim is confirmed at 146, server 14 control may jump to block 149 in FIG. 30A where the payor for the open claim is selected as a possible payor for current activity fees. After block 149, instead of checking the patient in at block 168, control passes to block 150 where a query about a work place injury is made to continue the process of identifying all possible payors.

Referring again to FIG. 4A, at block 160 where a worker's compensation payor is identified as a possible payor, control passes to block 163 in FIG. 30B where the worker's compensation payor is selected as a possible payor. After block 163, control passes to block 182 in FIG. 4B where a query about third party liability is made to continue the possible payor identifying process.

At block 192 in FIG. 4B, where a third party insurance company is confirmed as a payor control passes to block 199 in FIG. 30C where the insurance company is selected as a possible payor for activity fees after which control passes back to block 198 in FIG. 4B to continue the payor identification process.

At block 212, where a GSMPP is confirmed as a payor, control passes to block 215 in FIG. 30D where the GSMPP is selected as a possible payor for activity fees. After block 215 control passes to block 232 in FIG. 4C where the server attempts to confirm the patient's personal insurance as a possible payor.

Referring to FIG. 46, at block 234 where the patient's personal insurance is confirmed as a payor, control passes to block 237 in FIG. 30E where the personal insurance is selected as a possible payor. Next, with all possible fee payors identified, at block 239 the coordination rules 31 are accessed and at block 241 the rules are applied to identify final payors for the fees to be incurred. At block 243 the patient is notified of any required co-pay and at block 245 the check in process is completed.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, in at least some embodiments, while one or more payers may be identified by server 14 during the check-in process, the final arbiter of who pays fees may be a facility billing specialist or the like who confirms that benefits coordination rules have been properly applied. Similarly, in at least some embodiments, it is contemplated that where server 14 cannot discern payor status of two or more possible payors, collected information or a derivative (e.g., a summary) thereof may be provided to a facility billing specialist using administrator terminal 73 (see FIG. 1) or the like to sort out payor status using the collected information.

In addition, although not described above, it is contemplated that server 14 may facilitate a process for obtaining additional information from other sources when required to confirm a payer's willingness to pay fees. For instance, where an insurance company requires a primary care physician (PCP) to refer a patient to a specialist to cover specialist fees and the patient's EMR does not contain a referral notice, server 14 may be programmed to automatically seek a referral from the PCP in some electronic fashion. To this end, referring again to FIG. 1, a PCP server 71 is linked to network 16 and may be queried for a referral accessible by server 71 or a request for a referral may be sent to server 71 which then coordinates the process of obtaining a referral authorization from the PCP (e.g., via an e-mail). After a referral is obtained, assuming other criteria for confirming payor liability is met, the payor may be selected.

Moreover, payor confirmation may be facilitated by any of server 14, the payor servers 29 or some type of insurance clearing house (e.g., Availity, PesSe, etc.) server that stores insurance policy information for a large number of insurance companies. Similarly, benefits coordination rules may be applied by anyone of a combination of server 14, servers 29 and a clearing house type server.

To apprise the public of the scope of this invention, the following claims are made:

What is claimed is:

1. A system for use by a patient that participates in an activity at a medical facility, the system for coordinating patient benefits among a plurality of different possible payors including at least first and second payors other than the patient wherein each of the first and second payors are possibly responsible for payment of at least some activities associated with the patient, the system comprising:
a human-machine interface;
a database that stores a rules based wizard program designed to elicit information from a patient needed to determine which of the at least first and second payors will pay for specific patient activities during a visit to a medical facility;
a processor linked to the database and the interface, the processor running the wizard program to perform the steps of, when a patient accesses the interface:
(i) presenting questions to the patient via the interface other than a question regarding the identity of a payor for a first activity at the facility;
(ii) receiving answers to the questions via the interface; and
(iii) selecting one of the at least first and second possible payors for the first activity as a function of the answers to the questions.

2. The system of claim 1 further including an electronic medical records database that stores, among other things, separate medical records associated with each facility patient, the processor running the wizard program to further perform the steps of obtaining identification information from the patient, accessing a medical record associated with the identified patient and selecting questions to be presented to the patient as a function of information stored in the associated medical record.

3. The system of claim 2 wherein the medical record associated with a patient includes information related to an open claim and payors for activities associated with the open claim, at least one of the questions formulated to determine if the first activity is associated with at least one of the open claims.

4. The system of claim 3 wherein, when the first activity is associated with at least one open claim in the medical record, the processor selects a payor by selecting the payor for activities associated with the open claim.

5. The system of claim 1 further including a processor that, after at least one payor is selected, runs a confirmation program to perform a confirmation process for establishing that the payor will likely pay for the first activity.

6. The system of claim 5 further including an administrator terminal, the confirmation process further including presenting information to an administrator via the administrator terminal and receiving a confirming input via the terminal that the selected payor will likely pay for the first activity.

7. The system of claim 5 wherein, after confirming that the payor will pay for the first activity, the processor provides a confirming notice via the interface to inform the patient that the first activity will be paid for by the selected payor.

8. The system of claim 5 wherein the confirmation program includes confirming via the interface that the selected payor has agreed to pay for at least some facility activities for the patient.

9. The system of claim 1 wherein the interface includes a kiosk located at the medical facility.

10. The system of claim 9 wherein the kiosk is a check in kiosk and wherein the processor requires the payor selection step be performed prior to the patient checking in for an appointment at the facility.

11. The system of claim 1 wherein the processor is further programmed to provide confirmation to the patient via the interface that the selected payor will pay for the activity.

12. The system of claim 1 wherein the plurality of payors further includes at least a third payor that is the patient.

13. The system of claim 1 wherein each of the first and second payors is an insurance company.

14. The system of claim 1 wherein at least one of the first and second payors is a government sponsored medical payor program and wherein the step of presenting questions to the patient includes at least presenting a secondary payor form and requesting that the patient confirm that information in the form is accurate.

15. The system of claim 1 wherein at least one of the questions is formulated to ascertain relatedness of the first activity to a work related injury and, where the activity is related to a work related injury, other questions are formulated to identify information related to a worker's compensation account.

16. The system of claim 1 wherein at least one of the questions is formulated to ascertain relatedness of the first activity to an accident and, where the activity is related to an accident, other questions are formulated to identify information related to the accident.

17. A system for use by a patient that participates in an activity at a medical facility, the system for coordinating patient benefits among a plurality of different possible payors, the system comprising:
a human-machine interface;
a database that stores benefits coordination rules usable to ascertain liability for fees for activities at the facility;
a processor linked to the database and the interface, the processor running the wizard program to perform the steps of, when a patient accesses the interface:
(i) obtaining information from the patient regarding at least one activity at the facility; and
(ii) applying the benefits coordination rules to identify at least two payors other than the patient for the at least one activity at the facility.

18. The system of claim 17 wherein the step of applying the benefits coordination rules further includes applying the rules to divide at least a portion of the fees for the at least one activity among the at least two payors.

19. The system of claim 17 further including an electronic medical records database that stores, among other things, separate medical records associated with each facility patient, the step of obtaining information from the patient including obtaining identification information from the patient, accessing a medical record associated with the patient, selecting questions to be presented to the patient as a function of information stored in the associated medical record and obtaining answers to the questions.

20. The system of claim 17 further including a processor that, after at least two payors are selected, runs a confirmation program to perform a confirmation process for establishing that the at least two payors will likely pay for the at least one activity.

21. The system of claim 20 further including an administrator terminal, the confirmation process including presenting information to an administrator via the administrator terminal and receiving a confirming input via the terminal that the at least two payors will likely pay for the at least one activity.

22. The system of claim 20 wherein, after confirming likely payors, the processor provides a confirming notice via the interface to inform the patient that the at least one activity will be paid for by the at least first and second payors.

23. The system of claim 17 wherein the interface includes a kiosk located at the medical facility.

24. The system of claim 23 wherein the kiosk is a check in kiosk and wherein the processor requires the payor identifying step be performed prior to the patient checking in for an appointment at the facility.

25. The system of claim 1 wherein each of the at least two payors is an insurance company.

26. A method for coordinating patient benefits among a plurality of different possible payors for activities that the patient participates in at a medical facility, the method for use where there are a plurality of possible payors other than the patient wherein each of the plurality of possible payors are possibly responsible for payment of at least some activities associated with the patient, the method comprising the steps of:
providing a human-machine interface;
providing a database that stores a rules based wizard program designed to elicit information from a patient needed to determine which of the at least first and second payors will pay for specific patient activities during a visit to a medical facility;
running the wizard program to perform the steps of, when a patient accesses the interface:
(i) presenting questions to the patient via the interface other than a question regarding the identity of a payor for a first activity at the facility;
(ii) receiving answers to the questions via the interface; and
(iii) selecting one of the at least first and second possible payors for the first activity as a function of the answers to the questions.

27. The method of claim 26 further including the steps of providing an electronic medical records database that stores, among other things, separate medical records associated with each facility patient, running the wizard program to further perform the steps of obtaining identification information from the patient, accessing a medical record associated with the identified patient and selecting questions to be presented to the patient as a function of information stored in the associated medical record.

28. A method for coordinating patient benefits among a plurality of different possible payors for activities that a patient participates in at a medical facility, the method comprising the steps of:
providing a human-machine interface;
providing a database that stores benefits coordination rules usable to ascertain liability for fees for activities at the facility;
running a wizard program to perform the steps of, when a patient accesses the interface:
(i) obtaining information from the patient regarding at least one activity at the facility; and
(ii) applying the benefits coordination rules to identify at least two payors other than the patient for the at least one activity at the facility.

29. The method of claim 28 wherein the step of applying the benefits coordination rules further includes applying the rules to divide at least a portion of the fees for the at least one activity among the at least two payors.

30. A method for checking a patient in for an appointment at a medical facility where the patient has a primary care physician (PCP), the method comprising the steps of:
providing an interface for use by the patient;
providing a database including a payor rule that specifies that the patient needs a referral to be checked in for a specific activity and that stores referral information including instances of referrals;
providing a processor that performs the steps of, when the patient uses the interface to attempt to check in for an activity,
(i) accessing the database and determining that a referral is required for the activity that the patient is attempting the check in for;
(ii) determining that no database referral corresponds with the activity that the patient is attempting to check in for; and
(iii) electronically transmitting a message to the patient's PCP indicating that a referral is required.
